(19) United States
(12) Patent Application Publication
(10) Pub. No.: US 2026/0122753 A1
(43) Pub. Date: Apr. 30, 2026

(54) SUPPORT STRUCTURE FOR CHARGED PARTICLE BEAM TARGET

(71) Applicant: TAE Technologies, Inc., Foothill Ranch, CA (US)

(72) Inventor: Michael P. Meekins, Silverado, CA (US)

(21) Appl. No.: 18/678,180

(22) Filed: May 30, 2024

Related U.S. Application Data
(60) Provisional application No. 63/505,114, filed on May 31, 2023.

(51) Int. Cl. H05H 3/06; G21G 4/02

(52) U.S. Cl. CPC H05H 3/06; G21G 4/02

(57) ABSTRACT

The present disclosure provides a system comprising: an ion source configured to generate an ion beam; and a tandem accelerator configured to accelerate the ion beam, convert the ion beam to a proton beam, and accelerate the proton beam towards a neutron-generating target, the neutron generating target being configured to emit a neutron beam along a beam path to an object and comprising: a first layer comprising lithium; and a support structure comprising a plate having a surface supporting the first layer, the support structure comprising one or more channels adjacent the plate defining a continuous fluid path connecting an inlet channel to an outlet channel, the one or more channels comprising non-planar channel segments following curved paths.

### CROSS-REFERENCE TO RELATED APPLICATION

This application claims priority to U.S. Provisional Application No. 63/505,114 filed May 31, 2023, the contents of which are incorporated by reference herein.

### TECHNICAL FIELD

The subject matter described herein relates generally to a support structure for a charged particle beam target. The support structure includes a plate that supports a neutron-generating layer, and contains fluid flow channels adjacent to the plate for effective cooling of the target during operation.

### BACKGROUND

Cancer is one of the leading causes of death in contemporary society. The numbers of new cancer cases and deaths is increasing each year. Locally invasive malignant tumors, such as brain cancer, cancers of head and neck, and cutaneous and extracutaneuous melanomas, are of particular concern as the effective means to treat or inhibit growth of those cancers is limited.

Boron neutron capture therapy (BNCT) is a modality of treatment of a variety of types of cancer, including some of the most difficult types. BNCT is a technique that selectively aims to treat tumor cells while sparing the normal cells using a boron compound. BNCT, uses an accelerator-based neutron source to generate short-lived alpha-particles from boron-10 accumulated in the patients' tumor tissues. These alpha-particles selectively kill tumor cells while avoiding any damage to healthy organs and tissues. The boron compound allows for efficient uptake by a variety of cell types and selective drug accumulation at target sites, such as tumor cells. Boron loaded cells can be irradiated with neutrons (e.g., in the form of a neutron beam). The neutrons react with the boron to eradicate the tumor cells.

Neutron beams for BNCT can be generated through various techniques. In some cases, this is accomplished by colliding protons with a neutron generating target containing lithium-7 to generate neutrons according to the Li-7(p,n)Be-7 nuclear reaction. In other cases, the neutrons can be generated by impacting a target containing beryllium-9 with a proton beam (Be-9(p,n)B-9) or deuteron beam (Be-9(d,n)B-10) at different energies. Still other techniques can be used. The charged particles react with nuclei in the target to emit a beam of raw neutrons that can be used for BNCT.

### SUMMARY

The present disclosure provides a neutron generation target, useful to produce neutrons when irradiated by a charged particle beam (e.g., a proton beam). Such neutron beams are suitable for irradiation of tissue having a boron-containing compound in a boron-neutron capture therapy (“BNCT”) of cancer. In certain examples, accelerator-based BNCT utilizes a beam of epithermal neutrons produced via the nuclear reaction Li-7(p,n)Be-7 to treat various types of tumors. The target used to generate the neutrons has a finite lifetime and is periodically replaced.

In order to keep personnel safe when removing and handling the irradiated target, the exposure can be reduced by minimizing the amount and type of activated material in the target. The amount of material composing the target can be reduced using an integrated design. Generative design and advanced manufacturing techniques can be utilized to improve target performance while reducing the mass of materials composing the target, particularly materials that are easily activated.

A target having an integrated design includes a neutron-generating layer of a material that emits neutrons when irradiated with the charged particle beam, and a support structure including a plate that supports the layer. The plate and support structure are integrated into one single piece that also provides cooling to the neutron-generating layer. To remove heat from the neutron-generating layer, the support structure includes cooling channels for circulating a coolant (e.g., water) over the plate. The support structure is a monolithic structure with a cooling channel design that can reduce the amount of material used, improve mechanical support, and/or improve heat transfer compared to conventional designs.

The disclosed techniques use equation-based design systems combined with additive manufacturing techniques to achieve support designs that can provide improved heat transfer and robust mechanical support for a neutron-generating layer in a target. Channels providing heat transfer surfaces, as well as coolant inlet and outlets, are integrated into a single piece of material for the target support. Thus, the mass of potentially activated waste is reduced compared to targets that use components of different materials. By using an additive manufacturing technique, the heat transfer surfaces can be connected intermittently using advanced features such as lattice structures which allow high pressure cooling without a heavy bolted structure. Using additive techniques to form a monolithic heat-transferring support structure significantly minimizes bolting, brazing, and sealing features used in conventional support structures.

The disclosed neutron target assemblies can thus reduce the size, mass, and number of different materials composing a neutron target. Because of these reductions, the disclosed methods and devices can facilitate safer target exchange and storage capabilities because the targets are composed of less activated material at the end of their useful life compared to conventional targets. The targets of this disclosure also lead to significant improvement in terms of waste storage by minimizing the amount of irradiated target material that goes into waste.

While the structures and techniques described are in the context of a support structure for a neutron beam target, the disclosed techniques can be applied more generally to other heat removal applications. For example, the disclosed heat transfer units can be used for beam dumps, Faraday cups or other similar diagnostics where high heat flux components are located in a high radiation area. The disclosed systems and techniques can be applied to first wall or plasma facing component construction where high heat flux walls are located in high radiation environments.

Unless otherwise defined, all technical and scientific terms used herein have the same meaning as commonly understood by one of ordinary skill in the art to which the present application belongs. Methods and materials are described herein for use in the present application; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

Other features and advantages of the present application will be apparent from the following detailed description and figures, and from the claims.

### DESCRIPTION OF DRAWINGS

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A is a schematic diagram of an example of a neutron beam system.

FIG. 1B is a schematic diagram of another example of a neutron beam system.

FIG. 2A is a perspective view of an example of a circular neutron-generating target.

FIG. 2B is a perspective view of an example of a rectangular neutron-generating target.

FIG. 2C is a side view of a vertical cross-section of an example of an assembly securing a neutron-generating target.

FIG. 2D is a cross-sectional view of an example of an assembly for housing a neutron generating target.

FIG. 3A is side view of a vertical cross-section along a length dimension of an example support structure.

FIGS. 3B and 3C are a side view of a vertical cross-section along a length dimension of an example support structure with reinforcement beams.

FIG. 3D is a top perspective view of a vertical cross-section along a length dimension of an example support structure.

FIG. 3E is a bottom perspective view of a vertical cross-section along a length dimension of an example support structure.

FIG. 4A is a top perspective view of a vertical cross-section along a width dimension of an example support structure.

FIG. 4B is a bottom perspective view of a vertical cross-section along a width dimension of an example support structure.

FIGS. 5A and 5B show an example gyroid segment from a side perspective.

FIGS. 5C and 5D show an example gyroid segment from a diagonal perspective.

FIG. 6A is a block diagram of an example of association between a controller with computer instructions and a three-dimensional printer for making a support structure.

FIG. 6B is a flow chart of an example of a process of making a neutron-generating target including a support structure and a lithium layer.

FIG. 7 is a flow chart of an example of a process to treat cancer in a patient.

FIG. 8 is a schematic diagram of a computer system.

In the drawings, like numerals denote like elements.

### DETAILED DESCRIPTION

The articles described herein can be implemented in variety of applications where it is desired to reduce heating of a layer of a material by supporting the layer with a support structure with cooling channels. In the examples described in detail below, the layer is a lithium layer, which is adhered to the support structure by mechanical forces. The lithium-coupling examples can be used in both medical and non-medical applications. Suitable examples of non-medical applications include fusion reactors, scientific tools for nuclear physics research (e.g., Faraday cups to catch charged particles in a vacuum), industrial manufacturing processes, beam systems for the alteration of material properties (e.g., surface treatment and transmutation), beam systems for the irradiation of food, and non-medical imaging applications (e.g., cargo or container inspection). Suitable examples of medical applications include beam systems for pathogen destruction and medical sterilization, medical diagnostic systems, medical imaging systems, and radiation therapy systems (e.g., X-ray machines, Cobalt-60 machines, linear accelerators, proton beam machines, and neutron beam machines). One example of a medical application of the lithium coupling implementations described herein is a neutron-generating target for boron neutron capture therapy (“BNCT”).

Generally, boron neutron capture therapy (“BNCT”) is a type of treatment of a variety of types of cancer, including many cancer types that are challenging to treat. Examples of such cancers include liver cancer (including liver metastases), oral cancer, colon cancer, brain cancer such as glioblastoma, head and neck cancer, lung cancer, extensive squamous cell carcinoma, laryngeal cancer, and melanoma. BNCT is a technique that selectively aims to treat tumor cells while sparing the normal cells using a chemical compound containing non-radioactive isotope boron-10, which has a high propensity to capture low energy “thermal” or “epithermal” neutrons. In this technique, a boron-containing compound is administered to a patient (e.g., by injecting a parenteral composition to a blood vessel of the patient), allowing boron-10 to selectively collect in tumor cells. Suitable examples of boron delivery agents that can be administered to the cancer patients include boronated amino acids, boron nitride nanotubes, liposome and immunoliposomes carrying particles of boron, various boron-containing nanoparticles, boronated cyclic or acyclic peptides having affinity to cancer cells (e.g., boronated arginylglycylaspartic acid, “RGD,” or a cyclic version thereof), boronated compounds having affinity to receptors overexpressed in cancer cells, boronated sugars, and boronic acid. Generally, these compounds are capable of selectively accumulating within malignant tumors while avoiding healthy tissues (e.g., at least about 85 wt. %, at least about 90 wt. %, at least about 95 wt. %, or at least about 99 wt. % of the boron compound accumulates in the tumor tissue as opposed to the healthy tissues). For example, upon administration of the boron carrier compound, tumor concentration of boron can be obtained in the range of about 20-50 μg ¹⁰B/g tumor. The tumor concentration of boron can be determined by any means generally known to physicians for this purpose, such as imaging, calibration, and/or biopsy. Once a sufficient amount of boron-10 has collected within the tumor, the patient receives radiation in the form of a neutron beam at or near the tumor site.

Typically, to produce a neutron beam, a neutron generating material, such as lithium, is bombarded with protons of sufficient energy (e.g., energy above the Li⁷→Be⁷ reaction threshold of 1.88 MeV), whereby the protons are generated in an ion accelerator from a beam of negative hydrogen ions. The neutron-generating reaction may be described as follows, where p represents a proton and n represents a neutron:

$${Li}^{7} ( 3 p , 4 n ) + p = {Be}^{7} ( 4 p , 3 n ) + n \qquad ( eq . 1 )$$

The resulting neutron beam is moderated and focused on the patient, where the neutrons react with the boron-10 in the tumor cells to generate two short-range particles, an alpha particle (He⁴) and a lithium-7 particle, that selectively kills the tumor cells:

$${B}^{10} ( 5 p , 5 n ) + n = {Li}^{7} ( 3 p , 4 n ) + {He}^{4} ( 2 p , 2 n ) \qquad ( eq . 2 )$$

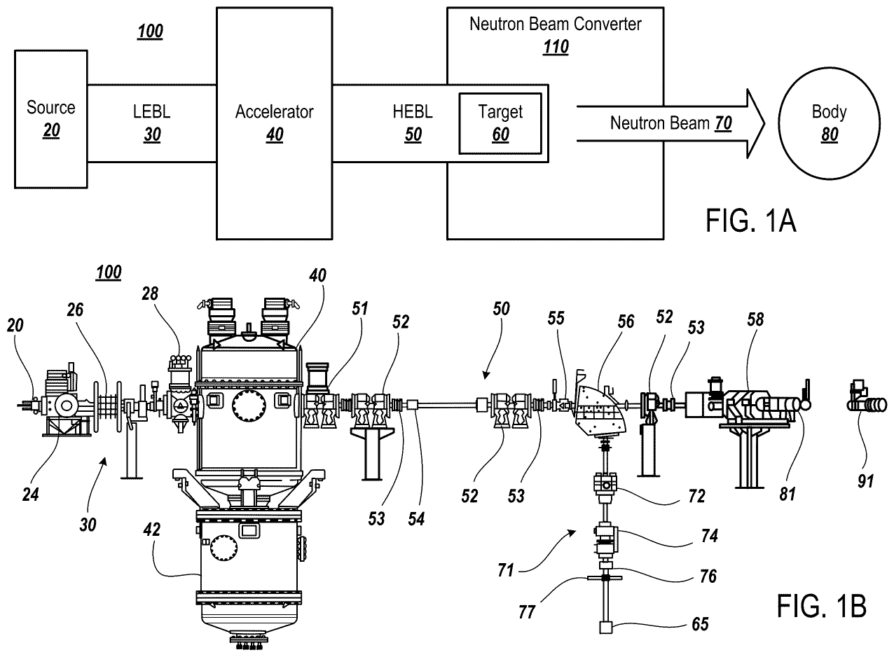

FIG. 1A illustrates a schematic view of an example of a system 100 for use in BNCT, in accordance with the present disclosure. System 100 is configured to create a charged particle beam and propagate it to a target 60 to generate a neutron beam 70 that is directed towards a patient body 80 to be irradiated. Beam system 100 includes a charged particle source 20, a low-energy beamline (LEBL) 30, an accelerator 40, and a high-energy beamline (HEBL) 50. Source 20 is configured to generate the charged particle beam, which is output to LEBL 30. LEBL 30 is configured to transport the beam from source 20 to accelerator 40. Accelerator 40 is configured to accelerate the charged particle beam to a higher energy. HEBL 50 extends from the accelerator 40 to target 60 housed within a target assembly portion of HEBL 50. HEBL 50 transfers the charged particle beam from an output of accelerator 40 to target 60, where it is converted to neutron beam 70.

Neutron beam converter (NBC) 110 is positioned close to and around target 60 to perform various functions on the neutrons of beam 70 emanating from target 60. These functions include reducing the energy of generated neutrons from energies above the desired range to within the desired range, focusing the generated neutrons in a forward-facing direction towards the patient, removing generated neutrons that are outside the desired range, and removing other radiation byproducts (e.g., such as photons) at energy levels that are undesirable. The desired neutron energy range can vary based on the application. For the BNCT applications described herein, the desired energy range can be, for example, one eV to ten keV, or one eV to thirty keV, with the neutron distribution peaking near the upper end of the desired range. For example, a one eV to 30 keV beam can be configured to output at least 90% of the neutrons in that energy range with a peak neutron distribution and an average energy between 10 keV and 30 keV. By way of another example, a one eV to ten keV beam can be configured to output at least 90% of the neutrons in that energy range with a peak neutron distribution and an average energy between three keV and 10 keV. For convenience, these ranges will be described as epithermal energy ranges. Neutrons at energies beneath these ranges will be referred to as thermal neutrons (e.g., beneath one eV), and those above these ranges will be referred to as fast neutrons (e.g., above 30 keV).

FIG. 1B is a schematic view illustrating an example of beam system 100 configured as a neutron beam system for use in BNCT. Beam system 100 includes a pre-accelerator system 26 forming at least a portion of LEBL 30, where pre-accelerator system 26 serves as a charged particle beam injector. System 100 includes a high voltage (HV) tandem accelerator 40 coupled to LEBL 30, and HEBL 50 extending from tandem accelerator 40 to a target 60, as described with reference to FIG. 1A.

LEBL 30 transfers a negative ion beam (e.g., H− ions) from ion source 20, through pre-accelerator system 26 which boosts the energy level of the ion beam and converges the ion beam, to an input (e.g., an input aperture) of accelerator 40. Accelerator 40 is powered by a high voltage power supply 42 coupled thereto. Accelerator 40 includes a vacuum tank, a charge-exchange tube, accelerating electrodes, and a high voltage feedthrough. Accelerator 40 can, in some implementations, accelerate a hydrogen ion beam to and convert the ion beam to produce a proton beam with an energy generally equal to twice the voltage applied to the accelerating electrodes positioned within accelerator 40. The energy level of the proton beam can be achieved by accelerating the beam of negative hydrogen ions from the input of accelerator 40 to the innermost high-potential electrode, stripping two electrons from each ion, and then accelerating the resulting protons downstream by the same voltages encountered in reverse order.

HEBL 50 can transfer the proton beam from the output of accelerator 40 to the neutron-generating target 60 positioned at the end of a branch 71 of the beamline extending into a patient treatment room. Beam system 100 can be configured to direct the proton beam to one or more targets 60 and associated target areas. In some implementations, HEBL 50 includes multiple (e.g., three) branches 71, 81, and 91 configured to extend to multiple different patient treatment rooms, with each branch terminating in a target 60 and NBC 110. HEBL 50 includes a pumping chamber 51, quadrupole magnets 52 and 72 to prevent de-focusing of the beam, dipole or bending magnets 56 and 58 to steer the beam towards one or more targets, beam correctors 53, diagnostics such as current monitors 54 and 76, a fast beam position monitor 55 section, and a scanning magnet 74 for branch 71. Branches 81 and 91 can contain components similar to branch 71.

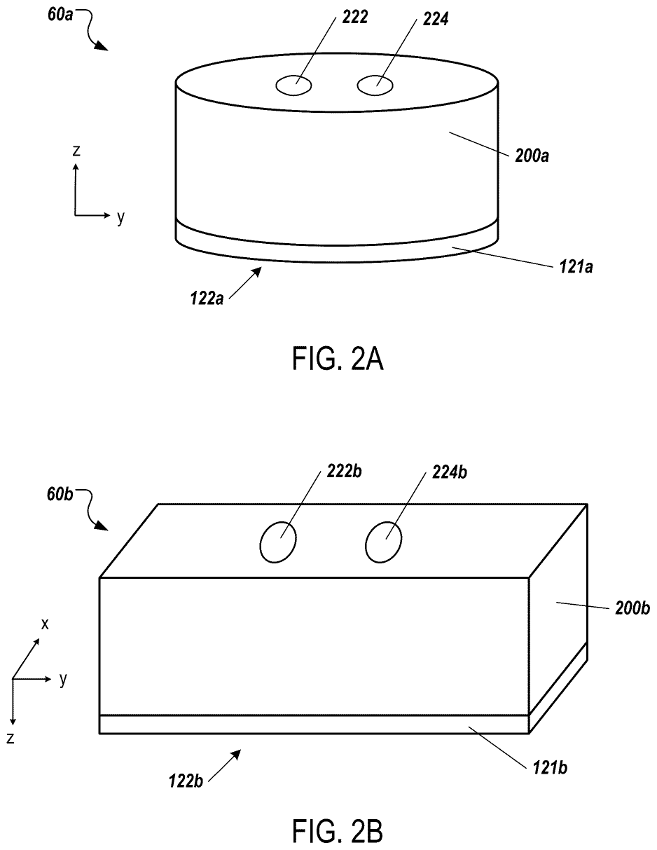

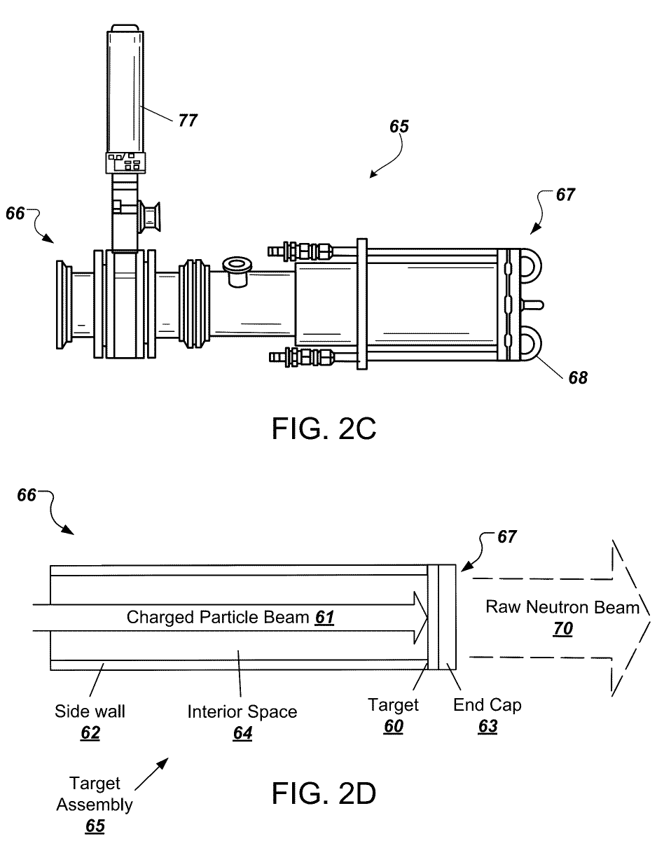

The design of HEBL 50 depends on the configuration of the treatment facility (e.g., a single-story treatment facility, a two-story treatment facility, and the like). The beam can be delivered to target 60 (e.g., positioned near a treatment room having a patient 80) with the use of the bending magnet 56. Quadrupole magnets 72 can be included to then focus the beam to a certain size at target 60. The beam can pass one or more scanning magnets 74, which provide lateral movement of the beam onto the target surface in a desired pattern (e.g., spiral, curved, stepped in rows and columns, combinations thereof, and others). The beam lateral movement can enable generation of smooth and even time-averaged distribution of the proton beam on the target 60, preventing overheating of the target and making the particle (e.g., neutron) generation as uniform as possible across the neutron generating layer (e.g., layer 121a of FIG. 2A and layer 121b of FIG. 2B).

Bending dipole magnets 74 can be configured to direct the beam to a current monitor 76, which measures beam current. The beam current value can be used to operate a safety interlock. The target assembly 65 containing target 60 can be physically separated from the high-energy beamline volume with a valve 77. A function of valve 77 is to separate the vacuum volume of the beamline from the target 60 during removal of a used target and loading of a new target. In some implementations, instead of being bent by 90 degrees by a bending magnet 56, the beam can be directed straight to one or more quadrupole magnets 52 located in the horizontal beamline. The beam could be bent by another bending magnet 58 to a preset angle, depending on a setting requirement (e.g., location of a patient or a room configuration). In some implementations, bending magnet 58 can be arranged at a split in the beamline and can be configured to direct the beam in one of two directions for two different treatment rooms located on the same floor of a medical facility.

System 100 as described with respect to FIG. 1B is one example of different configurations that can be used to generate charged particle and neutron beams. Different configurations of system 100 can utilize accelerators other than electrostatic tandem accelerators, and can utilize targets that are either fixed or rotating. The examples of NBC 110 described herein are not limited to use with any one type of neutron beam generating system.

In one general aspect, the present disclosure provides a lithium-containing target useful in applications where various forms of radiation are required. One example of the lithium-containing target of this disclosure is a neutron-generating target, such as target 60 within the target assembly 65 (with reference to FIGS. 1A and 1), useful to produce a beam of neutrons for bombarding a boron-containing compound administered to a patient during BNCT.

Generally, any target assembly has a finite lifetime and requires multiple replacements annually as the lithium turns into beryllium during the proton bombardment of lithium and the neutron generation reaction (see, eq. 1 above). As a byproduct, the reaction typically produces a large amount of heat that needs to be removed during the target operation to avoid melting lithium. As such, the target is usually made from a highly thermally conductive material, such as copper, gold, or silver, to facilitate removal of heat from lithium. However, as another by-product of the nuclear reaction required to produce the neutrons, the highly thermally conductive material also becomes radioactive, emitting various gamma rays through a variety of nuclear decay processes that have lifetimes of several hours, days, or months. In the existing BNCT targets, due to the high pressure water required for effective target cooling, the part of the target that is made from the thermally conductive, radioactive material is thick and massive. The large amount of this material in the target ensures robustness necessary to support the differential water pressure, and to maintain all vacuum and water seals. In addition, the massive target is usually mounted within a holding device (which supports the target plate, provides hermetic sealing for the required water cooling, and maintains vacuum). Within this device, the thick thermally conductive plate is clamped between several other thick plates (such as aluminum plates) with several high strength steel bolts to create the required seal and provide an interface with the inlet and outlet water. But when the target is made from a large amount of the easily activatable, radioactive material, the irradiated target prior to replacement is a significant radiological hazard. Because the targets are exchanged partially by hand and then stored in a storage area in the basement of the facility, all interactions with the target (exchanging, transporting, and storing) pose significant safety concerns and the radiation exposure of the personnel can be substantial. In some instances, the expected dose to personnel in close proximity to the target assembly, post irradiation, may exceed the allowable annual whole-body dose of 20 millisieverts (msV).

Accordingly, the present disclosure provides an integrated neutron-generation target with substantially reduced size, mass, and amount of easily activatable material required for an efficient neutron target. The target within the present disclosure includes a thin thermoconductive plate integrated with a support structure. The support structure, in turn, includes fluid flow channels adjacent to the thermoconductive plate for efficient water cooling. Thus, in addition to providing support for the lithium layer, the support structure functions as a heat transfer unit for the target. In addition, the target of this disclosure can be supported within the holding device only at the outer diameter, such that it does not require clamping the target using heavy steel bolts to create water and/or vacuum seal. Because of this, the overall outer diameter of the target can be smaller compared to currently used targets that are clamped by steel bolts between aluminum plates. A target having an integrated design includes several different target features incorporated into a single part. For example, with an integrated design, the target is a solid piece of material including a plate for supporting a lithium layer and cooling channels that are integral with the plate and configured to transport fluid coolant past the plate. The integrated design can significantly reduce the amount of material that is susceptible to radiation and is exposed to radiation. The targets of this disclosure maintain all of their operational aspects (such as providing support for lithium in vacuum chamber and efficient water cooling to avoid lithium melting) and show optimized performance while having dramatically decreased size, mass, and residual radioactivity. The reduced mass and size of the targets promotes safety of the personnel handling the target replacement and transportation by reducing exposure to irradiation. In addition, the total amount of radioactive waste material going into storage is minimized, further reducing the amount and size of shielding casks required for the waste storage.

In some examples, target is provided as an article including a lithium layer and a support structure with a plate that supports the lithium layer. Referring to FIGS. 1A and 1, an example article is a target 60. The target 60 may be useful to produce a beam of neutrons for bombarding a boron-containing compound administered to a patient during BNCT. In some examples, the weight of the target 60 is from about 20 g to about 1,000 g, from about 100 g to about 1,000 g, from about 200 g to about 800 g, from about 250 g to about 1,000 g, or from about 500 g to about 1,000 g.

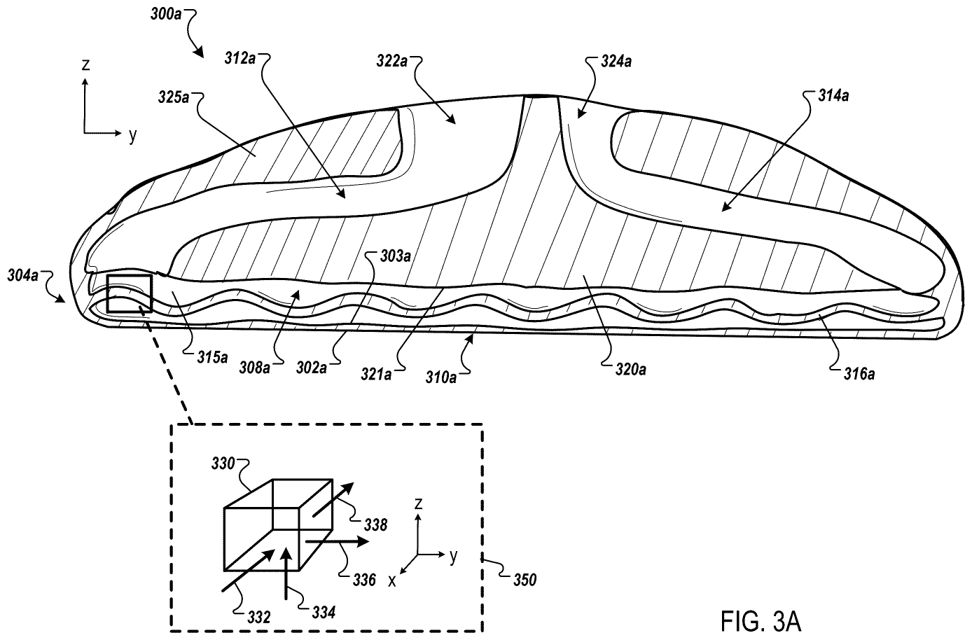

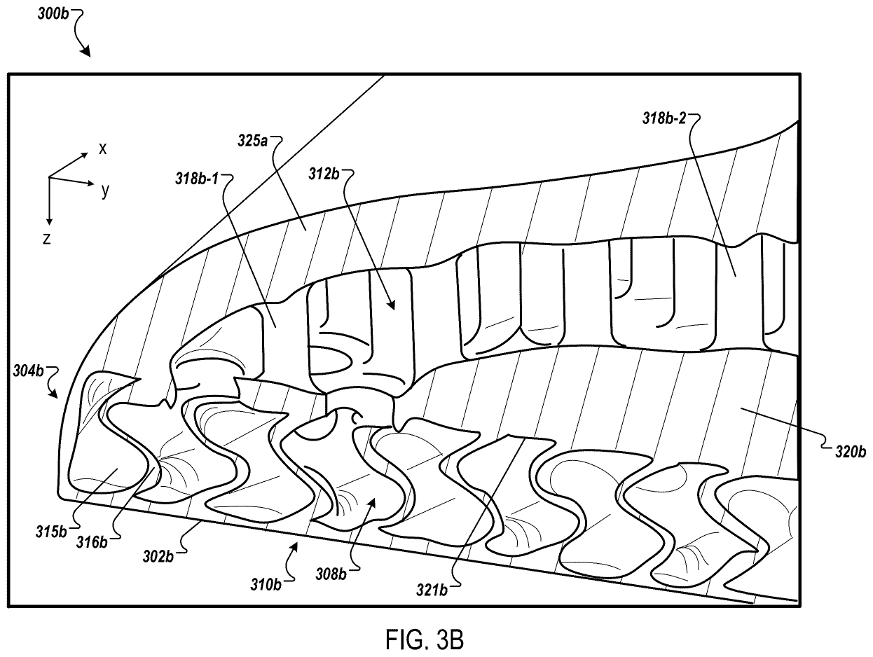

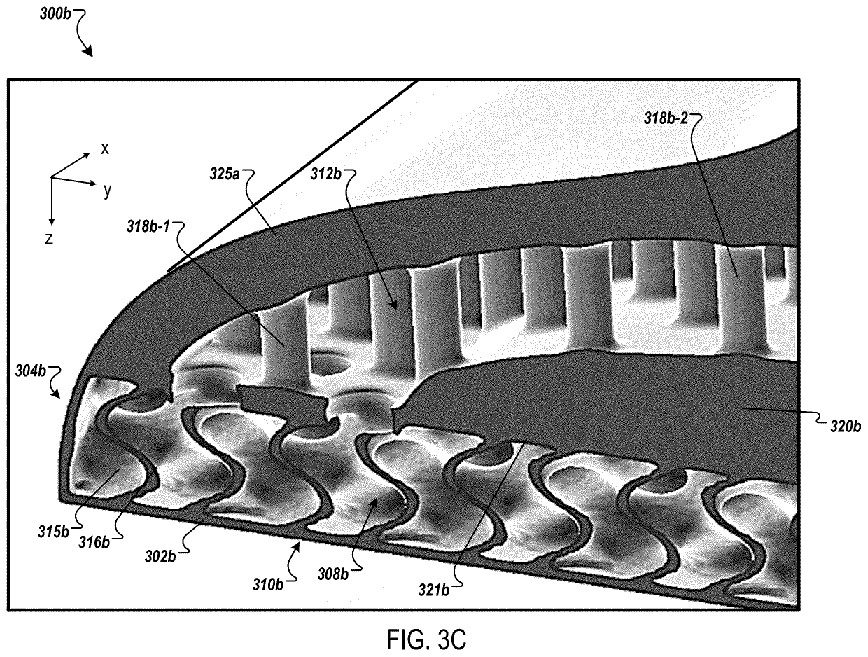

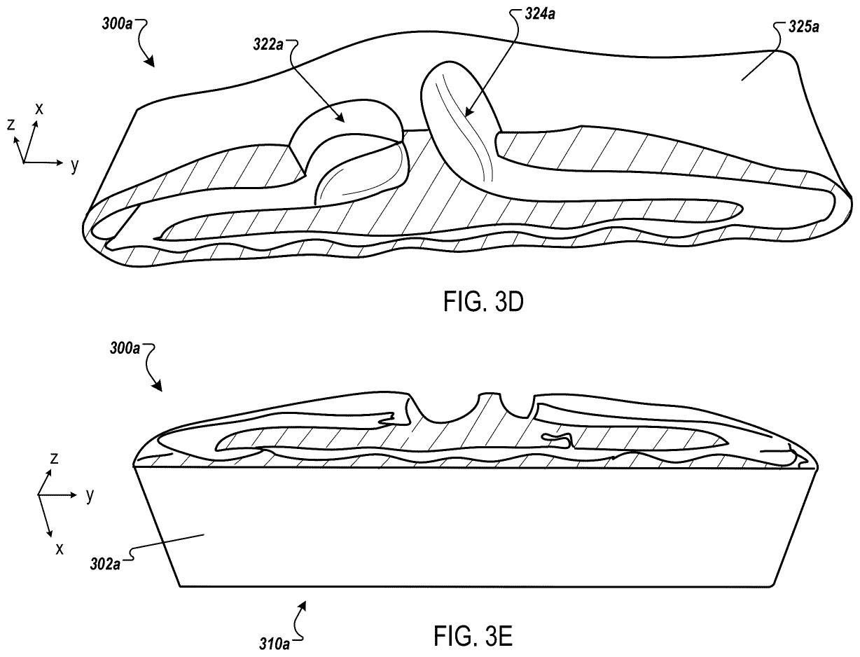

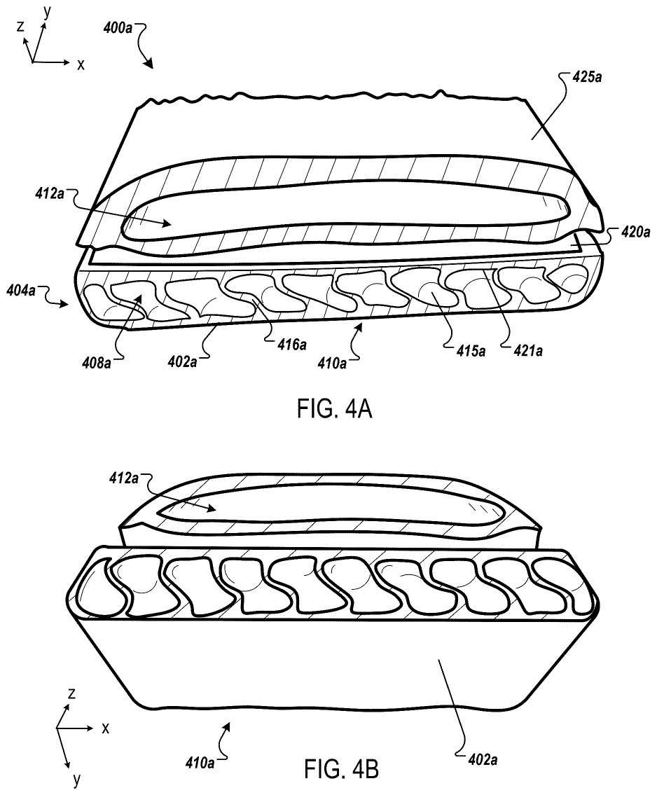

FIG. 2A is a perspective view of an example of a circular neutron-generating target 60a. In this example target 60a has a first layer, or neutron generating layer 121a, with a charged particle receiving face surface 122a. The neutron generating layer 121a can be a lithium layer, and is positioned on or in proximity to a heat transfer unit, e.g., support structure 200a. In some cases, layer 121a is covered with one or more other layers for protection. Layer 121a can also have one or more underlying layers between layer 121a and support structure 200a, e.g., to resist blister formation. A charged particle beam, such as a proton beam, incident upon face 122, passes into target 60a and causes layer 121a to undergo a reaction that generates neutrons. This is the Li-7(p,n)Be-7 nuclear reaction in the case where neutron generating layer 121a is composed of lithium-7. Neutron generating layer 121a can alternatively be beryllium-9, and neutrons can be generated with a proton beam (Be-9(p,n)B-9) or deuteron beam (Be-9(d,n)B-10) at different energies. Support structure 200a can be a material with excellent thermal conductivity, such as copper or aluminum, to assist in removal of the heat generated by the reactions. The support structure 200a includes inlet port 222a and outlet port 224a. During operation, fluid coolant can enter the support structure 200a through inlet port 222a and can exit the support structure 200a through outlet port 224a. Within the support structure 133a, cooling channels fluidly connect the inlet port 232a to the outlet port 234a. Cross sectional views of example support structures are shown in FIGS. 3 and 4.

FIG. 2B is a perspective view of an example of a rectangular neutron-generating target 60b. Similar to target 60a, target 60b has a neutron generating layer 121b with a charged particle receiving face surface 122b. Neutron generating layer 121b is positioned on or in proximity to a support structure 200b. In some cases, layer 121b is covered with one or more other layers for protection. The target 60b can also include one or more underlying layers between layer 121b and support structure 200, e.g., to resist blister formation. A charged particle beam, such as a proton beam, incident upon surface 122b, passes into target 60b and causes layer 121b to undergo a reaction that generates neutrons. This is the Li-7(p,n)Be-7 nuclear reaction in the case where neutron generating layer 121b is composed of lithium-7. Neutron generating layer 121b can alternatively be beryllium-9, and neutrons can be generated with a proton beam (Be-9(p,n)B-9) or deuteron beam (Be-9(d,n)B-10) at different energies. Support structure 200b can be formed from a material with excellent thermal conductivity, such as copper or aluminum, to assist in removal of the heat generated by the reactions. The support structure 200b includes inlet port 222b and outlet port 224b. During operation, fluid coolant can enter the support structure 200b through inlet port 222b and can exit the support structure 200b through outlet port 224b. Within the support structure 200b, cooling channels fluidly connect the inlet port 232 to the outlet port 234.

Generally, a target 60 can be of any known shape and can be made to fit in the target assembly (e.g., target assembly 65 referring to FIG. 1). Suitable examples of shapes for a target 60 include a circle, a triangle, a rectangle, a square, a rhombus, a trapezoid, a pentagon, a hexagon, or any combination of the foregoing. In some examples, the shape of the neutron generating layer 121 is the same as the shape of the article of this disclosure (e.g., the neutron-generating targets 60a, 60b). In this example, the neutron generating layer 121 and the support structure 200 have substantially the same shape (e.g., a circle, a square, a rectangle, a pentagon, or a hexagon). In some examples, the target of this disclosure (including layer 121a and support structure 200a) has a circular shape. The diameter of the circular article may be 5 centimeter (cm) or more, 7 cm or more, 10 cm or more, 15 cm or more, 20 cm or more, from about 5 cm to about 20 cm, from about 5 cm to about 15 cm, or from about 5 cm to about 10 cm. In some examples, the neutron generating layer 121 and the support structure 200 may have different shapes. For example, neutron generating layer 121 may be a circle and the support structure 200 may have a square or rhombus shape.

The neutron generating layer 121 may include from about 90 wt. % to about 99 wt. % of lithium. In this example, the neutron generating layer 121 can contain about 90 wt. %, about 95 wt. %, or about 99 wt. % or more of lithium. Generally, the lithium layer is supported by a surface of the support structure (e.g., the lithium layer is adhered to the surface of a plate of the support structure 200). An example of the neutron generating layer of lithium is neutron generating layer 121a in target 60a shown in FIG. 2A. The lithium in this layer may be a naturally occurring lithium composed of two stable isotopes, Li⁶ and Li⁷. An amount of Li⁷ isotope in the naturally occurring lithium material may range from about 90 wt. % to about 99 wt. %, or from about 92 wt. % to about 98 wt. %. In some examples, the lithium in the neutron generating layer 121 is enriched in Li⁷ and depleted in Li⁶, such that the lithium material contains about 99.9 wt. % or about 100 wt. % of Li⁷. The lithium in layer 121 may also contain other isotopes of lithium, such as Li³, Li⁴, Li⁸, Li¹¹, or Li¹², or any combination thereof with the Li⁶ and/or Li⁷ isotopes.

A neutron generating layer 121 may be configured as a substantially planar neutron generation layer. FIG. 1A provides an example of using the lithium layer in a neutron-generation reaction. Referring to FIG. 1A, a proton beam propagating from tandem accelerator 40 along HEBL 50) interacts with the neutron generating layer 121 to produce neutrons that, in turn, pass through target 60 and exit downstream of target 60. The thickness of the neutron generating layer 121 (e.g., the distance between the outer surface of the neutron generating layer 121 and the surface of the plate of the support structure) can be selected depending on the energy of the propagating protons. It is practically desirable to have a sufficiently thick lithium layer for the neutron-producing target, but not so thick (e.g., 200 μm for the 2.5 MeV proton energy) that reduction of the proton's energy below the threshold dissipates excessive heat in the lithium or produces undesirable gamma-radiation.

In some examples, the thickness of the neutron generating layer 121 is from about 15 μm to about 180 μm, from about 20 μm to about 150 μm, from about 40 μm to about 120 μm, from about 80 μm to about 120 μm, or from about 90 μm to about 100 μm. In some examples, the proton energy is from about 2 MeV to about 3 MeV, or from about 2.25 MeV to about 2.75 MeV In some examples, the proton energy is about 2.5 MeV and the thickness of the lithium layer on the support structure surface is about 90 μm or about 100 μm.

Generally, in the articles of this disclosure, such as target 60, the neutron generating layer is supported by a surface of a plate of the support structure. In some examples, being supported by the surface refers to the neutron generating layer 121 being bonded to (e.g., adhered to) the surface. The bonding may occur through metallic bonds, electrostatic interactions, intermaterial diffusion, or any combination of the foregoing, between the lithium in neutron generating layer 121 and the material of the plate. For example, the desired support and bonding may be achieved during making of the target 60, as described more fully below. In some examples, a protective covering (e.g., a passivation region) can be positioned over the neutron generating layer 121 (e.g., by applying the covering to the outer surface of the neutron generating layer 121).

FIG. 2C is a side view of an example of a target assembly 65 that can form a terminal portion of HEBL 50. Target 60 (not shown) can be contained within assembly 65 at or near end 67. The charged particle beam enters assembly 65 at end 66 and travels to the opposite end 67 where it impacts target 60. Various cooling channels 68 are routed to and from end 67 for the insertion and removal of coolant used to regulate the temperature of target 60 during use. Numerous sensors can be included to monitor temperature and radioactivity of and around assembly 65. Also shown is valve 77 in the example form of a gate valve. End 67 of assembly 65 is inserted into an aperture 205 (FIG. 3A) within NBC 110 where it remains during BNCT procedures. Assembly 65 (with target 60) can be removed from NBC 110 and disposed of upon reaching the end of its usable lifetime, at which point a new assembly 65 and target 60 can be inserted into NBC 110.

FIG. 2D is a cross-sectional view of an example of target assembly 65 omitting components such as valve 77, coolant channels and sensor connections for clarity. A sidewall 62 has a tubular shape and contains an interior space 64 at a vacuum or near vacuum level. Target 60 is positioned at end 67 and held in place by end cap 63. Variations of this construction are possible, such as with target 60 surrounded by sidewall 62. Charged particle beam 61 is directed through interior space 64 and scanned across target 60 by scanning magnet 74 located upstream on HEBL 50 (not shown). Neutrons produced by target 60 are emitted in all directions from target 60, but the majority of the neutrons are emitted in a dispersed but generally forward direction. This is depicted here as neutron beam 70 in raw form.

Additive manufacturing operations include manufacturing operations in which an object is created by building the object one layer at a time. Additive manufacturing can include using computer-aided-design (CAD) software and/or 3D object scanners to create a design for an object. Software then translates the design into a layer-by-layer framework for an additive manufacturing machine (e.g., a three-dimensional printer) to follow. Manufacturing instructions are sent to the additive manufacturing machine, which includes hardware that deposits material, layer upon layer, in precise geometric shapes to create the object. In some examples, a nozzle lays successive layers of material on top of each other until the final product is complete. Additive manufacturing can be used to create complex 3D entities. Making the target support structure using additive manufacturing techniques therefore allows the support structure to be made with complex shapes, such lattices.

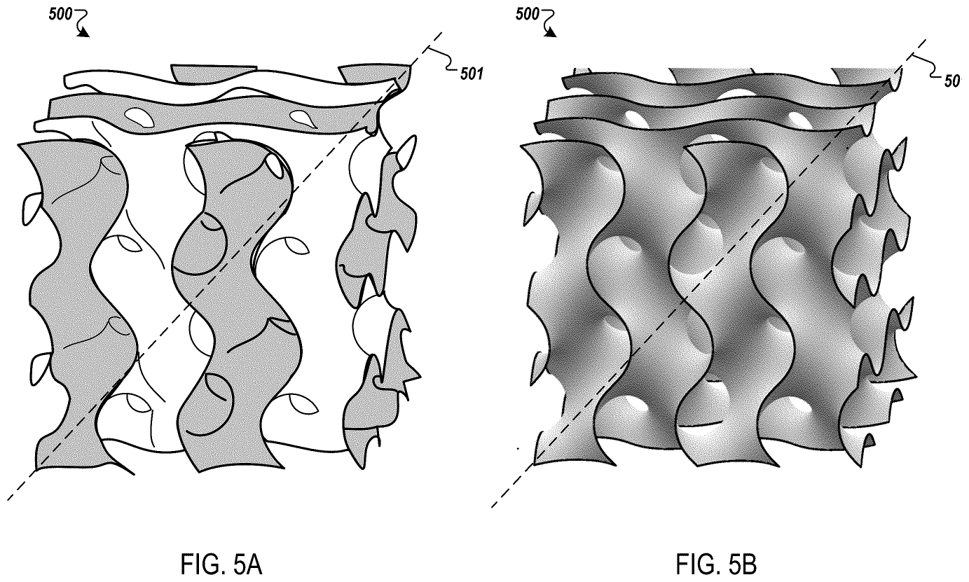

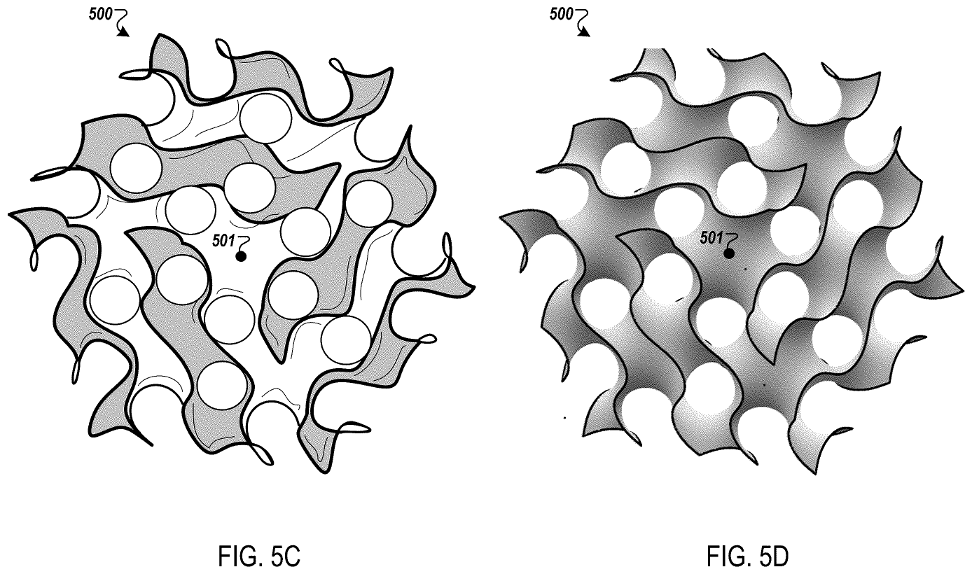

Lattices have internal connective elements which provide internal reinforcement and additional heat transfer area. For example, a lattice can include micro-architectures with a network of nodes and beams or struts. A lattice design reduces weight while retaining structural integrity. Interlinking portions of a lattice can enhance various areas of performance and use up less material without weakening the object or compromising its integrity. A lattice is composed of cell structures which are individual building blocks of the lattice, and allows for covering a large surface area with minimal interfering parts. Each cell represents a repeatable shape and can come in varying shapes and sizes. In some examples, a lattice can have a gyroidal form. A gyroid is formed from a complex continuous surface that defines cells of the gyroid. Gyroids are described in greater detail with reference to FIGS. 5A and 5B. When a lattice is built into a support structure of a target, internal connective elements form the walls of the interconnected cooling channels. The internal connective elements increase heat transfer properties of the support structure and distribute the stress and strain of high pressure cooling fluid so that thinner walls can be used. In addition, the connective elements provide more uniform support across the area of the plate, compared to a support structure that only provides support in the center or around the edges of the plate. As a result, the plate supporting the neutron-generating layer can be thinner than would otherwise be possible, thereby reducing the overall mass of the target. In this way, using additive manufacturing to create complex shapes enables construction of a support structure with a relatively small amount of material that still provides sufficient mechanical support and adequate cooling to the active neutron-generating layer.

Because the support uses a relatively small amount of material, the target is smaller than conventional targets. Because the target is smaller, there is less radioactive material once the target is used. Due to the reduced amount of radioactive material, a shielding cask storing the target can be reduced in size and weight, improving the ease and safety of target handling, transportation, and storage.

FIG. 3A is side view of a vertical (z-dimension) cross-section along a length dimension (y-dimension) of an example support structure 300a in accordance with implementations of the present disclosure. The support structure 300a is capable of functioning as a beam dump. A beam dump, also known as a beam block, a beam stop, or a beam trap, is a device designed to absorb the energy of photons or other particles within an energetic beam (e.g., a photon beam, a neutral beam, an electron beam, or other charged particle beam). The support structure 300a includes a plate 310a.

The plate 310a is a thin, flat portion of the support structure 300a. The plate 310a has a surface 302a for supporting a lithium layer (e.g., layer 121 of FIG. 2A or layer 131 of FIG. 2B). The surface 302a can be, for example, a planar surface that extends in the x-y plane. The surface 302a is external to the support structure 300a. During operation, the surface 302a faces in the direction of the source of the incident charged particle beam. The plate 310a has a second surface 303a that is opposite from the first surface 302a. The second surface 303a is internal to the support structure 300a. During operation, the surface 303a faces away from the direction of the source of the incident charged particle beam. The second surface 303a of the plate 310a connects to a lattice structure 304a internal to the support structure 300a, such that the plate 310a and the lattice structure 304a are monolithic. The plate 310a connects, at its edges, to outer walls 325a of the support structure 300a. A shape of the plate 310a in the x-y plane can be, for example, quadrilateral (e.g., square, rectangular) or rounded (e.g., circular, elliptical, ovoidal).

When the support structure 300 is integrated with the lithium layer, the resulting article can be used as a neutron-generating target. In some examples, being supported by the surface 302a of the plate 310 refers to the lithium layer being bonded to the surface 302a through diffusion (or alloying) of lithium into the material of the surface 302a (e.g., copper).

In some examples, the vertical cross-section (e.g., cross section in the z-direction) of the support structure 300a is an intersection of a plane perpendicular to the surface 302a of the plate 310a. This intersection may have any shape depending on the three-dimensional shape of the support structure. Examples of a vertical cross-sections of the support structure include a triangle, a rectangle, a square, a rhombus, a trapezoid, a parallelogram, or any combination of the foregoing.

The support structure 300a includes a second plate 320a. In some examples, the second plate 320a has a surface 321a that extends in a plane parallel or nearly parallel to the plate 310a. The support structure 300a includes a lattice structure 304a. The lattice structure 304a abuts the plate 310a and conforms to the plate 310a. The lattice structure 304a fills a volume 308a between the plate 310a and the second plate 320a.

The support structure 300a includes an inlet channel 312a and an outlet channel 314a. The support structure 300a includes an inlet port 322a and an outlet port 324a. During operation, the support structure 300 functions as a heat transfer unit. During operation, a fluid coolant is introduced to the inlet channel 312a through the inlet port 322a. The coolant travels from the inlet channel 312a to the lattice structure 304a to the outlet channel 314a. The coolant removes heat from the plate 310a while traveling through the lattice structure 304a. The coolant egresses from the outlet channel 314a through the outlet port 324a.

The inlet channel 312a and the outlet channel 314a fluidly couple to the lattice structure 304a at outer edges of the support structure 300a. Thus, the direction of fluid coolant flow through the lattice structure 304a is generally in the y-direction (e.g., left to right in FIG. 3A). In some examples, the inlet channel 312a, the outlet channel 314a, or both, can fluidly couple to the lattice structure 304 at other locations within the support structure 300, such as at or near the middle of the support structure 300a in the x-y plane. In some examples, the inlet channel 312a fluidly couples to a center region of the lattice structure 304a, and the outlet channel 314a fluidly couples to outer regions of the lattice structure 304a. In these examples, the direction of fluid coolant flow through the lattice structure 304a is generally in an outward direction (e.g., radially outward from the center region in the x-y plane). In some examples, the inlet channel 312a fluidly couples to outer regions of the lattice structure 304a, and the outlet channel 314a fluidly couples to an inner region of the lattice structure 304a. In these examples, the direction of fluid coolant flow through the lattice structure 304a is generally in an inward direction (e.g., radially inward from the outer regions in the x-y plane towards the center region).

The second plate 320a is positioned between the lattice structure 304a and the inlet and outlet ports 322a, 324a. The inlet channel 312a fluidly couples the volume 308a between the plate 310a and the second plate 320a with the inlet port 322a. The outlet channel 314a fluidly couples the volume 308a with the outlet port 324a.

The support structure 300a includes one or more fluid conduits, or channels 315a, that are formed by the lattice structure 304a and are adjacent the plate 310a. The channels 315a define a continuous fluid path connecting the inlet channel 312a to the outlet channel 314a. The channels 315a can be formed in vortex-inducing geometries. The geometries of the channels 315a can cause fluid to undulate in three dimensions while traversing through the lattice structure 304a between the inlet channel 312a and the outlet channel 314a. The flow path from the inlet port 322a, to the inlet channel 312a, through the channels 315, to the outlet channel 314a, to the outlet port 324a, has no right angles.

A lattice structure (e.g., lattice structure 304a) is a repeated pattern that fill a volume and/or conform to a surface. A lattice structure can include beams, surfaces, or plates that fit together following an ordered or stochastic pattern. The lattice structure 304a includes internally connected heat transfer surfaces formed from the wall 316a. In some examples, the lattice structure 304a is formed by a triply periodic minimal surface having zero mean curvature. In some examples, the lattice structure 304a excludes straight lines and planar symmetries. The lattice structure 304a can include superposed and connected layers that define a three-dimensional periodic pattern. The lattice structure 304a can be an engineered cellular structure forming a periodic nodal surface. The lattice structure 304 can be formed in a layer-by-layer three dimensional printing operation. The lattice structure 304 can include cells propagating in three dimensions. The cells can be defined by a continuously curving wall 316a having openings. The openings in the wall 316a form flow paths throughout the lattice structure 304a from the inlet channel 312a to the outlet channel 314a.

In some examples, the lattice structure 304a is a multidimensional array of cells in which the cells are stacked along three orthogonal axes (e.g., x, y, and z). The arrangement of the cells permits the direction of fluid flow to move along all three axes through the support structure 300a. FIG. 3A includes a callout 350 showing example ingress and egress paths of coolant fluid from an example cell 330. Although shown in FIG. 3A as being cubic, cells of the lattice structure 304a can be curved. The cells of the lattice structure 304a can be non-uniform in shape, size, or both. In some examples, the individual cells of the lattice structure 304a can be configured individually, such that each cell is unique. In some examples, some of the cells can have the same shape and/or size as one another.

In some examples, a cell can accept fluid flow from adjacent cells in two or more directions. For example, referring to FIG. 3A, the cell 300 can accept fluid flow in an upward direction along the z-axis, as represented by arrow 334, and in an inward direction along the x-axis, as represented by arrow 332. The interior surfaces of the cell 300, which can be curved sidewalls, change the direction of at least some of the incoming fluid, and output the fluid to adjacent cells in two or more directions. For example, the cell 300 can output fluid flow in an inward direction along the x-axis, as represented by arrow 338, and in a sideways direction along the y-axis, as represented by arrow 336.

In some examples, for an individual cell, there is at least one input or output vector of fluid flow that lies along each of the x, y, and z-axes. In an example with two input directions and two output directions, adjacent cells can be oriented differently from each other in order to cause the fluid to disperse uniformly or near-uniformly through the structure. In some examples, fluid can enter a cell in three directions and exit the cell in three directions.

The cells of the lattice structure 304a direct the coolant fluid flow in multiple directions depending on the incoming heat flux from the surrounding surfaces. More flow will be directed and diverted to the hottest regions of the channels until a uniformly distributed temperature is achieved. Individual channels and cells can be adjusted depending on the expected incoming heat flux and the thermal conductivities of the materials that form the support structure 300a.

The geometries of the channels 315a improve the heat transfer from the plate 310a to coolant flowing through the channels 315a. In some examples, the channels 315a is composed entirely of non-planar channel segments following curved paths. In some examples, the channels 315a are defined by a surface having a gyroidal shape. Gyroidal shapes are described in greater detail with reference to FIGS. 5A and 5B.

The internal connections of the lattice structure 304a increase the pressure handling capability of the support structure 300a. This reduces the amount of material required to direct the coolant from the inlet channel 312a to the high heat flux surface (e.g., the interior surface of plate 310a) and to the outlet channel 314a. The lattice structure 304a is configured to direct the coolant flow in an optimized pattern to optimize the heat transfer from the plate 310a to the coolant. This improves heat handling capabilities of the target, enabling the use of an incident proton beam with higher power levels.

During operation, the support structure 300a functions as a heat transfer unit to remove heat from the lithium layer. The support structure 300a removes heat by various means. For example, heat can transfer by conduction from the lithium layer to the plate 310a. Heat from the plate 310a can then transfer by conduction to heat transfer surfaces of the lattice structure 304a, e.g., the wall 316a of the channels 315a. Heat can transfer by conduction from the wall 316a to fluid coolant in the channels 315a. Heat can transfer by conduction from the wall 316a to the second plate 320a, and from the plate 310a to outer walls 325a of the support structure 300a. Heat can transfer by radiation the second plate 320a and from the outer walls 325a of the support structure 300a to the environment. Heat can transfer by convection as the fluid coolant travels through the outlet channel 314a to the outlet port 324a. After egressing through the outlet port 324a, the coolant can be cooled by an external heat transfer system before re-entering the support structure 300 through the inlet port 322a.

The improved heat handling capabilities of the target permit the plate 310a to be thinner than would otherwise be possible. A thickness of the plate 310a can be measured as a distance between the first surface 302a and the second surface 303a. In some examples, a thickness of the plate 310a is from about 1 millimeter (mm) to about 8 mm. In some examples, the thickness of the plate 310a is selected from about 2 mm, about 3 mm, about 4 mm, about 5 mm, about 6 mm, or about 7 mm. In some examples, the plate 310a is about 2 times, about 5 times, about 10 times, about 20 times, about 50 times, about 60 times, about 70 times, about 80 times, about 90 times, or about 100 times thicker than the neutron generating layer.

The channels 315a are fluidly coupled to each other. In some examples, the height of a vertical cross-section (e.g., cross section in the z-direction) of any channel 315a is from about 0.1 mm to about 0.5 mm, from about 0.1 mm to about 1 mm, from about 0.5 mm to about 1 mm, from about 1 mm to about 2 mm, from about 1 mm to about 5 mm, from about 1 mm to about 7 mm, from about 1 mm to about 10 mm, from about 2 mm to about 3 mm, from about 3 mm to about 4 mm, or from about 4 mm to about 5 mm. In some examples, the width of a vertical cross-section of any channel 315 is from about 0.1 mm to about 1 mm, from about 0.1 mm to about 5 mm, from about 0.5 mm to about 1 mm, from about 1 mm to about 2 mm, from about 1 mm to about 5 mm, from about 1 mm to about 7 mm, from about 1 mm to about 10 mm, from about 2 mm to about 3 mm, from about 3 mm to about 4 mm, or from about 4 mm to about 5 mm.

In some examples, the channels 315a are defined by a continuously curving wall 316a. Examples of the thickness of the wall 316a include from about 0.1 millimeter (mm) to about 0.5 mm, from about 0.1 mm to about 1 mm, from about 1 mm to about 2 mm, from about 2 mm to about 3 mm, from about 3 mm to about 4 mm, or from about 4 mm to about 5 mm. In some examples, the wall 316 thickness is about 1 mm or less, about 2 mm or less, about 3 mm or less, about 4 mm or less, or about 5 mm or less. In some examples, thickness of the wall is about 1 mm, about 2 mm, about 3 mm, about 4 mm, or about 5 mm.

In some examples, the support structure 300 is formed in an additive manufacturing operation. In some examples, the support structure 300 is a monolithic structure that is cast as a single rigid unit. A monolithic structure is composed of a single chunk of hard material rather than an assembly of discrete parts. As a monolithic structure, the support structure 300 is devoid of seams and joints, such as braze and weld joints. The support structure 300 can be considered a three-dimensional single-piece construction which is composed of one solid continuous three-dimensional piece of material.

Generally, the support structure 300a for the article of this disclosure is made such that the article (e.g., neutron-generating target) is sufficiently robust to perform under the harsh conditions during target irradiation. The support structure 300a may contain elements to ensure that the target is securely affixed within the target assembly during operation. The thickness and other dimensions of the support structure 300a can be chosen to ensure that the structure is sturdy enough to withstand high pressure of the coolant fluid (e.g., water pressure) that flows through the support structure 300a to cool off the target 60 and prevent melting of the neutron generating layer 121 during operation. In some examples, the thickness of the support structure 300 (e.g., a distance between surface 302a and the inlet port 322a or outlet port 324a is from about 10 mm to about 50 mm, from about 10 mm to about 40 mm, or from about 10 mm to about 30 mm. At the same time, the support structure is also selected to minimize the use of highly-activatable materials and the overall weight of the target.

The support structure can be formed from one or more materials. In some examples, the support structure 300a is formed from copper. In some examples, the support structure 300a may be made from a material having thermal conductivity lesser than the thermal conductivity of the material of target 60. For example, thermal conductivity of the material of the support structure is below about 400 W×m⁻¹×K⁻¹, below about 300 W×m⁻¹×K⁻¹, below about 200 W×m⁻¹×K⁻¹, or from about 50 W×m⁻¹×K⁻¹ to about 300 W×m⁻¹×K⁻¹. In some examples, a thermal conductivity of the support structure 300a is from about 300 W×m⁻¹×K⁻¹ to about 1000 W×m⁻¹×K⁻¹. In some examples, a thermal conductivity of the support structure 300 is from about 50 W×m⁻¹×K⁻¹ to about 300 W×m⁻¹×K⁻¹. In some examples, density of the material of the support structure 300a is from about 1 gram per cubic centimeter (g/cm³) to about 10 g/cm³, or from about 2 g/cm³ to about 5 g/cm³. In some examples, the material of the support structure is a composite material containing one or more metals and one or more non-metals.

The support structure is designed to optimize the heat transfer coefficient between the coolant fluid and the material of the support structure. Heat can transfer from the coolant fluid to the material of the support structure at laminar flow conditions at which the Reynolds Number (Re) is 2000 or less, at turbulent flow conditions at which Re is 2000 or more, and at nucleate boiling conditions with optimized heat transfer. The surface finish on the interior surfaces of the support structure is capable of achieving high heat transfer coefficients (e.g., 10,000 W/m2*K or greater). The interior surfaces of the support structure can be textured with high roughness, or can be smooth finished with polished surfaces and low roughness. In some examples, some interior surfaces of the support structure have high roughness, and other interior surfaces of the support structure have low roughness. The integrated cooling channels increase effective heat transfer area, as all surfaces of the cooling channels contribute to cooling. The non-uniform cooling channels have more effective surface area than equivalent uniform cross-section channels.

FIGS. 3B and 3C are a side view of a vertical (z-dimension) cross-section along a length dimension (y-dimension) of an example support structure 300b, shown in a line drawing and in grayscale, respectively.

Similar to the support structure 300a, the support structure 300b includes a plate 310b. The plate 310b has a surface 302b for supporting a lithium layer. The support structure 300b includes a second plate 320b. The second plate 320b has a surface 321b that extends in a plane parallel or nearly parallel to the plate 310b. The support structure 300b includes a lattice structure 304b. The lattice structure 304b abuts the plate 310b and conforms to the plate 310b. The lattice structure 304b fills a volume 308b between the plate 310b and the second plate 320b. The support structure 300b includes one or more fluid conduits, or channels 315a, that are formed by the lattice structure 304 and are adjacent the plate 310b. The channels 315b are defined by a continuously curving wall 316a. The channels 315b define a continuous fluid path connecting the inlet channel 312b to the outlet channel.

The support structure 300b includes reinforcement beams, or support beams 318b, in the inlet channel 312b and the outlet channel (not shown). The support beams 318b extend in a vertical direction (z-direction). Example support beam 318b-1 couples at a bottom end to the wall 316b, and at the top end to the outer wall 325b. Example support beam 318b-2 couples at a bottom end to the second plate 320b, and at a top end to the outer wall 325b. In some examples, a support structure can include support beams in the inlet channel and not in the outlet channel. In some examples, a support structure can include support beams in the outlet channel and not in the inlet channel. The support beams 318 provide additional strength for the support structure 300b. The support beams also provide additional heat transfer surfaces for transferring heat from the plate 310b to fluid coolant in the inlet and outlet channels.

FIG. 3D is a top perspective view of a vertical cross-section (z-direction cross section) along a length dimension (y-dimension) of the example support structure 300a. FIG. 3C shows the inlet port 322a, outlet port 324a, and outer wall 325a. FIG. 3D is a bottom perspective view of a vertical cross-section along the length dimension of the example support structure 300a. FIG. 3E shows the plate 310a including the surface 302a. The support structure 300a has a rectangular shape. A length (e.g., in the y-direction) of the support structure 300a is from about 5 centimeters (cm) to about 20 cm. A weight of the support structure is from about 500 grams to about 1,000 grams.

FIG. 4A is a top perspective view of a vertical cross-section (z-direction cross section) along a width dimension (x-dimension) of an example support structure 400a. FIG. 4B is a bottom perspective view of a vertical cross-section along the width dimension of the example support structure 400a. The support structure 400a includes a plate 410a. The plate 410a has a surface 402a for supporting a lithium layer. The support structure 400a includes a second plate 420a. The second plate 420a has a surface 421a that extends in a plane parallel or nearly parallel to the plate 410a. The support structure 400a includes a lattice structure 404a. The lattice structure 404a abuts the plate 410a and conforms to the plate 410a. The lattice structure 404a fills a volume 408a between the plate 410a and the second plate 420a. The support structure 400a includes one or more fluid conduits, or channels 415a, that are formed by the lattice structure 404a and are adjacent the plate 410a. The channels 415a are defined by a continuously curving wall 416a. The channels 415a define a continuous fluid path connecting the inlet channel 412a to the outlet channel (not shown). FIG. 4A shows the inlet channel 412a and outer wall 425a. FIG. 4B shows the plate 410a including the surface 402a.

As described above, the lattice structure that forms the channels of a support structure can have a form based on a gyroid. The lattice structure can be formed by a repeated gyroid segment or pattern that fills a volume and/or conforms to a surface. FIGS. 5A and 5B show an example gyroid segment 500 from two different perspectives. The gyroid segment 500 is a piece of gyroid that is two unit cells in each direction. The lattice structure can be formed from multiple connected gyroid segments such as the gyroid segment 500.

The gyroid segment 500 forms an approximate cube. FIGS. 5A and 5B show the gyroid segment 500 from a side view of the cube in a line drawing and in grayscale, respectively. The gyroid segment 500 has a symmetry axis 501.

FIGS. 5C and 5D show the gyroid segment 500 from the perspective along the symmetry axis 501 in a line drawing and in grayscale, respectively. The symmetry axis 501 is a C3 symmetry axis, since the cube can be rotated about the axis 501 into three equivalent orientations, one hundred-twenty degrees apart.

The gyroid pattern can be used for lightweight internal structures, due to its high strength, combined with speed and ease of printing using a 3D printer. In this embodiment, the gyroid is a connected surface, and can be a multiply connected surface. A connected surface is a surface for which any two points on the surface can be connected by a curve lying wholly on the surface. A surface is considered to be simply connected if any simple closed curve can be shrunk to a point continuously in the set. A surface that is connected, but not simply connected, is considered to be multiply connected.

The gyroid can be uninterrupted by defined edges, large angles, rims, sides, corners, and seams, such that each portion of the gyroid is continuous with each other portion of the gyroid. A single gyroid structure (e.g., a single gyroid unit cell) can be formed from iso-surfaces described by sin(x)cos(y)+sin(y)cos(z)+sin(z)cos(x)>u(x, y, z), where the surface is constrained by u(x, y, z). The gyroid segment 500 can be formed from a triply periodic minimal surface with triple junctions. The gyroid segment 500 can be configured such that it does not have any reflectional symmetries (e.g., the gyroid segment has no planes of symmetry and/or embedded straight lines.

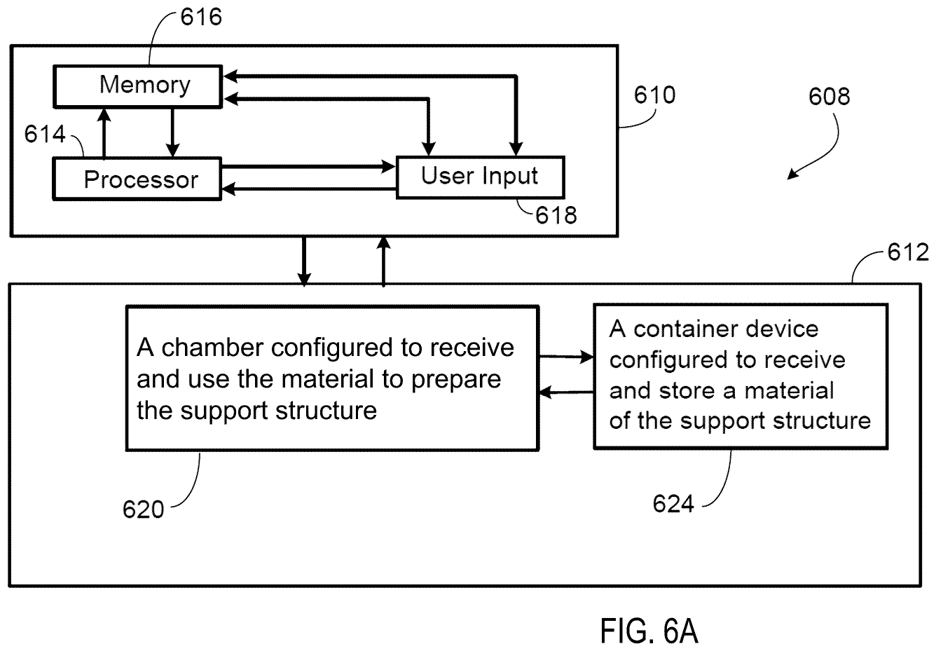

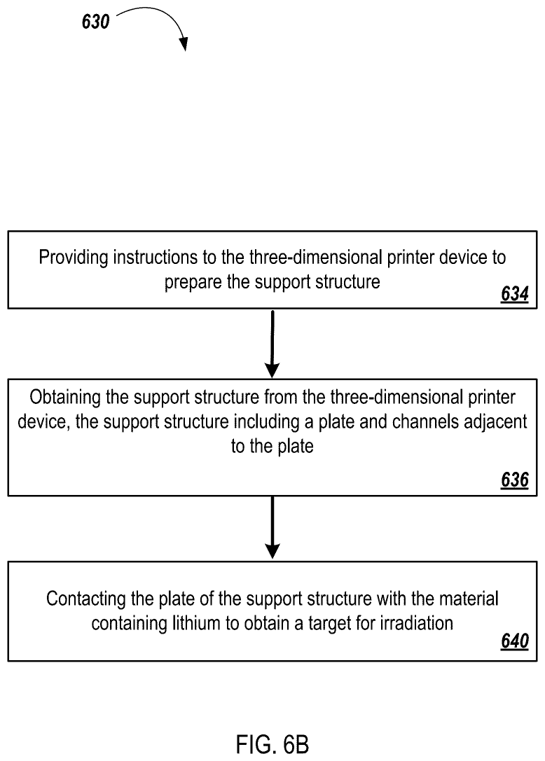

FIG. 6A generally shows an example of association 608 between controller 610 and the three-dimensional printer device 612. The printer device 612 can form the support structure in an additive manufacturing operation. The printer device can be, for example, a fused deposition modeling printer, a fused filament fabrication printer, a stereolithography printer, a digital light processing printer, a selective laser sintering printer, a selective laser melting printer, a laminated object manufacturing printer, a digital beam melting printer, or any combination thereof.

Referring to FIG. 6A, an example of the three-dimensional printer device 612 includes a container 624 with one or more materials of the support structure. The container 624 is configured to receive, store, and provide these material or materials to the chamber 620 for making the support structure. The chamber 620 is configured to receive the materials from the container 624, and to use these materials for making the support structure upon receipt of instructions from processor 614 within the controller 610.

Referring to FIG. 6A, the controller 610 includes processor 614, memory 616, and user input 618. Computer instructions are stored in the memory 616 and executable by the processor 614. In some examples, the controller 610 is configured to instruct the three-dimensional printer to prepare the support structure. The controller may be a standard personal computer, or the controller may be specifically assembled to be associated with and to operate the three-dimensional printer device. In one example, the controller and the printer device are located within a single piece of equipment. Alternatively, the controller and the printer can be separate pieces of equipment that are electronically connected (e.g., by a cable or cables).

All of the components of the controller 610, including processor, memory, and user input, are typically powered and connected electronically, for example, using a circuit board (mother board). In some examples, the memory 616 includes the necessary computer instructions to prepare the support structure. Generally, the computer instructions are communicated from the memory 616 to the processor 614 for execution. The processor 614 is configured to instruct the three-dimensional printer device 612 to prepare the support structure. User input 618 is connected to the memory 616 and the processor 614 and allows a user to influence the computer instructions, for example, by providing an algorithm (e.g., software with an algorithm) for making the support structure. For example, the algorithm may describe the making of the support structure 300a, including the channels 315a, the plate 310a and the second plate 320a, with each feature having the desired dimensions (e.g., height, length, depth, and/or width) and related parameters.

In some examples, the material stored and used in container 624 is any one of the materials of the support structure. The material can be stored in container 624 in any form that is suitable for using in three-dimensional printing. For example, the material in container 624 can be stored in a solid or a liquid form. One example of the solid form includes a particulate composition. For example, the material in container 624 can be in a form of particles having a mean diameter from about 0.1 micrometer (μm) to about 10 μm or from about 1 μm to about 5 μm. The container 624 may be heated as needed, for example, to a temperature from about 100° C. to about 300° C. or from about 150° C. to about 250° C.

The article (e.g., neutron-generating target) of this disclosure can be prepared by any method that is generally known in the art to adhere (or otherwise bond together) the two or more dissimilar materials. In one example, the article may be prepared by applying a layer of lithium to a support structure. Accordingly, the present disclosure provides methods of making the article.

FIG. 6B provides a flow chart of a process 630 for making a combination of a support structure and a first layer (a lithium layer) supported by that structure (e.g., a combination of layer 121 adhered to support structure 200).

The process 630 includes a step 634 of providing instructions to the three-dimensional printer device to prepare the support structure.

The process 630 also includes a step 636 of obtaining a support structure from the three-dimensional printer device. The support structure includes a plate and channels adjacent to the plate. The channels can be defined by a surface having a gyroidal form. The channels can be composed entirely of non-planar channel segments following curved paths. The channels can be defined by a continuously curving wall. In some examples, the support structure obtained in step 636 is a support structure as described above with reference to the FIGS. 3 and 4. Steps 634 and 636 can be a method of producing a support structure for use in wide applications.

The process 630 also includes a step 640 of contacting the plate of the support structure with a material containing lithium to obtain a target for irradiation. The step 640 can be performed to obtain a target for BNCT applications. In some examples, the step 640 can be a performed as a separate process from the process 630. The plate 310a of the support structure 300 can be contacted with the material containing lithium to obtain a neutron-generating target with a lithium layer (e.g., first layer 121). In some examples, during the contacting in step 640, the support structure and the lithium layer become bonded to each other, such that the lithium layer is supported uniformly (e.g., evenly) across the plate of the support structure. The uniform support provided for the material of the first layer by the support structure allows to decrease the overall thickness and mass of the target, leading to the advantages described above, e.g., the decreased exposure of personnel to residual radioactivity. The uniform support to the support structure also allows not to disrupt the flow and direction of the beam of neutrons, for example, when the target is used for neutron generation. The lithium layer and the support structure can be bonded to one another by any method generally known to reliably bond two dissimilar materials. Depending on the materials used to prepare the support structure and the support structure, these two elements may be bonded through metallic bonds, electrostatic interactions, intermaterial diffusion, or any combination of the foregoing. In some examples, the contacting step 640 may be carried out using brazing, welding, soldering, or by applying a mechanical force to either the lithium layer, the support structure, or both structural elements at the same time (e.g., during hot isostatic pressing). The mechanical force may range from about 1 megaPascal (MPa) to about 3 MPa. For example, the mechanical force is about 1 MPa, about 1.5 MPa, about 2 MPa, about 2.5 MPa, or about 3 MPa.

In some examples, the mechanical force is less than or about the compressive stresses of the material of the lithium layer. In some examples, the mechanical force is less than or about the compressive stresses of the material of the support structure. In one example, either the material of the first layer, or the support structure, or both, can be heated to facilitate the bonding. For example, to facilitate adhesion in step 640, either the lithium layer or the support structure, or both, can be heated during the contacting to a temperature from about 400 degrees Celsius (° C.) to about 1000° C., or from about 400° C. to about 700° C. The elements may be heated, for example during brazing and soldering, and also during pressing the elements together by mechanical force. For example, if the lithium layer and the support structure are bonding by soldering, a soldering iron or a hot air gun may be used. In another example, if a mechanical force is applied to either the lithium layer or the support structure, a hydraulic press or a hot isostatic pressing vessel may be used to apply the force and ensure bonding. These operations may be performed using the same tool or a piece of machinery. For example, a single instrument or a piece of equipment may be configured to facilitate initial contacting between the lithium layer and the support structure, and also to apply heat and pressure to these elements, as may be required. An example of such an instrument may be a mechanical press equipped with a robotic arm. These operations may also be performed using separate pieces of equipment. In another example, the contact between the lithium layer and the support structure may be initiated by hand or using an automated robotic arm, followed by using a mechanical press to bond the two elements to obtain the target of step 640.

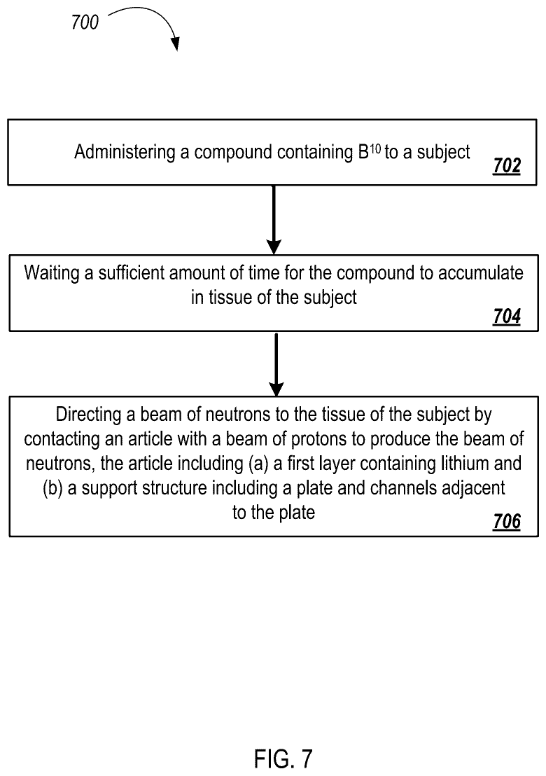

An example of a process 700 to treat cancer in a patient is provided with reference to FIG. 7. Referring to FIG. 7, the process 700 of treating cancer includes a step 702 of administering to the subject a therapeutically effective amount of a compound containing B¹⁰. Generally, the selected B¹⁰-containing compound has low systemic toxicity, rapid clearance from blood and normal tissues, high tumor uptake, and low normal tissue uptake. For example, the ratio of amount of B¹⁰ in tumor tissue to the amount of B¹⁰ in normal tissue after administration of the B¹⁰-compound is from about 2:1 to about 5:1 or from about 3:1 to about 4:1. In some examples, the therapeutic amount of the B¹⁰ compound is from about 1-100 mg of B¹⁰ for 1 kilogram (kg) of the subject's body weight. For example, the therapeutic amount of the B¹⁰-containing compound is from about 5 mg B¹⁰/kg to about 100 mg B¹⁰/kg, from about 5 mg B¹⁰/kg to about 80 mg B¹⁰/kg, or from about 5 mg B¹⁰/kg to about 40 mg B¹⁰/kg. The B¹⁰-containing compound can be administered to the subject in a pharmaceutical composition or a dosage form along with one or more pharmaceutically acceptable excipients. Suitable examples of such excipients include alumina, phosphate salts, colloidal silica, polyacrylates, polyethyleneglycol based polymers, and cellulose-based substances. The B¹⁰-containing compound can be administered to the subject by any suitable route of administration. For example, the compound may be administered orally, intradermally, or by intramuscular or intraperitoneal route. Examples of formulations and dosage forms for administering the B¹⁰ compound include tablets, capsules, and injectable solutions. Suitable examples of B¹⁰ compounds that can be administered to the subject include boronated derivatives of natural and unnatural amino acids, polyamines, peptides, proteins, antibodies, nucleosides, sugars, porphyrins, as well as the liposomes and nanoparticles. For example, the B¹⁰-containing compound is a boronated derivative of an amino acid such as aspartic acid, tyrosine, cysteine, methionine, or serine. In some examples, the B¹⁰-containing compound is boronophenylalanine, borocaptate sodium, or 1-amino-3-boronocyclo-pentanecarboxylic acid.

Referring to FIG. 7, the process 700 also includes a step of waiting a sufficient amount of time for the B¹⁰-containing compound to accumulate in the cancer tissue. The amount of waiting time may range from about 10 seconds (sec) to about 2 hours (h), from about 30 sec to about 1 h, or from about 1 min to about 30 minutes (min). In one example, the B¹⁰-containing compound may accumulate in the cancer tissue at a level from about 20 to about 50 microgram (μg) of B¹⁰ per gram (g) of tumor. The sufficient accumulation of B¹⁰ in the tumor can be determined, e.g., by a treating physician by any suitable technique. In one example, the level of B¹⁰ in the tumor can be determined using biopsy and elemental analysis of the tumor tissue. In another example, the level of B¹⁰ in the tumor tissue can be determined using imaging (e.g., fluorescent imaging, PET, X-ray, CT, or MRI).

The process 700 also includes a step 706 of directing a beam of neutrons to the tissue of the subject by contacting the article of this disclosure (e.g., the neutron-generating target 60 as described above) with a beam of protons of appropriate energy to produce the beam of neutrons. The article includes a first layer containing lithium and a support structure including a plate and channels adjacent to the plate. In some examples, the proton energy is from about 2 MeV to about 3 MeV, from about 2.2.5 MeV to about 2.75 MeV, or about 2.5 MeV The step 706 can be performed as described above with reference to FIGS. 1A and 1B. In some examples, during the operation of the target (e.g., in step 706), the target is kept at its operating temperature from about 130° C. to about 150° C. or from about 140° C. to about 150° C. For example, the target may be cooled by a flow of a coolant fluid through the target.

For example, with reference to FIG. 2B, the target 60, including support structure 300a, can be secured in the assembly 65 using a retaining ring O-rings. The coolant fluid may flow through inlet channel 312a, entering the target 60 through an opening 314a, then flowing through the channels 315a of the lattice structure 304a. The coolant fluid then flows toward outlet channel 314a to exit the target 60 through the outlet port 324a. While flowing through the channels 315a, the coolant fluid remains in continuous contact with the wall 316a of the support structure 300a, thereby cooling the neutron generating layer 121 to its operating temperature. Suitable examples of coolant fluid include water, alcohol (e.g., methanol, ethanol, or isopropanol), and antifreeze, or a mixture thereof. The coolant fluid may be selected such that the boiling point of the coolant fluid is from about 50° C. to about 150° C. In some examples, the coolant fluid is water. In some examples, the coolant fluid for cooling the target is substantially degassed. For example, the coolant fluid contains less than about 1 wt. %, less than about 0.5 wt. %, or less than about 0.1 wt. % of dissolved gas (e.g., air or nitrogen).

In some examples, the coolant fluid is substantially free from dissolved solid materials, such as inorganic salts (e.g., NaCl, MgSO₄ and the like). For example, the coolant fluid contains less than about 0.5 wt. %, less than about 0.2 wt. %, or less than about 0.1 wt. %, of the dissolved solids. In some examples, the coolant fluid flows through the target at a rate from about 10 kilogram per minute (kg/min) to about 200 kg/min, from about 30 kg/min to about 150 kg/min, from about 50 kg/min to about 100 kg/min, about 60 kg/min, about 70 kg/min, or about 80 kg/min. In some examples, the flow of the coolant fluid is a laminar flow. For example, the coolant fluid maintains laminar flow in the channels 315a when in continuous contact with the wall 316a. Suitable examples of Reynolds number for the laminar flow of the coolant fluid is from about 1 to about 1,500, from about 10 to about 1,000, or from about 100 to about 500. In some examples, the inlet temperature of the coolant fluid (e.g., at the inlet port 322a of the support structure 300) is from about 5° C. to about 30° C., from about 10° C. to about 25° C., about 15° C., or about 20° C. In some examples, the outlet temperature of the coolant fluid (e.g., at the edge 412 of the neutron generating layer 121) is from about 40° C. to about 90° C., from about 50° C. to about 80° C., about 60° C., or about 70° C. In some examples, the inlet pressure of the coolant fluid (e.g., at the inlet port 322a) is from about 100 kiloPascal (kPa) to about 200 kPa, from about 110 kPa to about 190 kPa, from about 120 kPa to about 180 kPa, from about 130 kPa to about 170 kPa, or from about 140 kPa to about 160 kPa. In some examples, the outlet pressure of the coolant fluid (e.g., at the edge 412 of the neutron generating layer 121) is from about 80 kPa to about 180 kPa, from about 100 kPa to about 170 kPa, or from about 120 kPa to about 150 kPa. For example, the difference between the inlet and outlet pressure of the coolant fluid may be about 5 kPa, about 8 kPa, 10 kPa, about 15 kPa, about 20 kPa, or about 50 kPa.

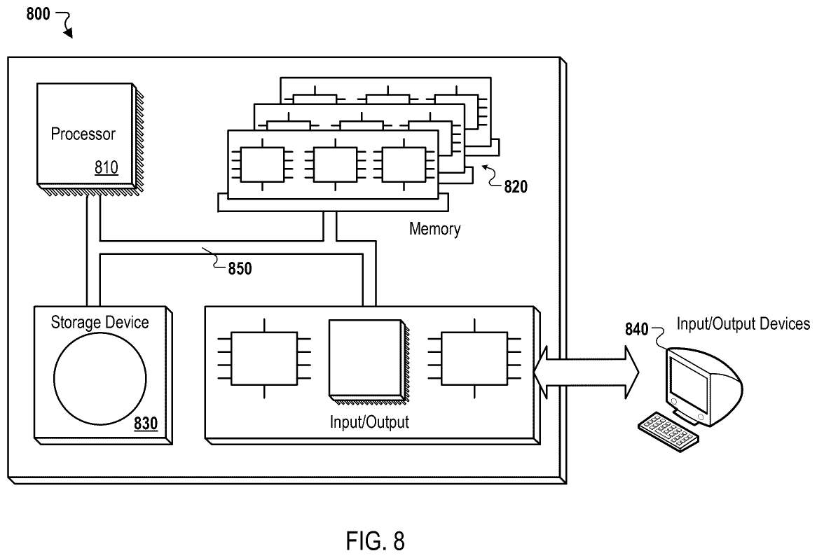

FIG. 8 is a schematic diagram of a computer system 800. The system 800 can be used to carry out the operations described in association with any of the computer-implemented methods described previously, according to some implementations. For example, the system 800 can be used to carry out operations associated with the three-dimensional printer device 612 as shown in FIG. 6A. The memory 820 can be, for example, the memory 616 of the three-dimensional printer device 612. The processor 810 can be, for example, the processor 614 of the three-dimensional printer device 612. The input/output device 840 can be used to obtain the user input 618 to the three-dimensional printer device 612. In some examples, the system 800 can be used to carry out the operations described in association with the process 630 for making a combination of a support structure and a lithium layer using a three-dimensional printer device, as described with reference to FIG. 6B.

In some implementations, computing systems and devices and the functional operations described in this specification can be implemented in digital electronic circuitry, in tangibly-embodied computer software or firmware, in computer hardware, including the structures disclosed in this specification (e.g., system 800) and their structural equivalents, or in combinations of one or more of them. The system 800 is intended to include various forms of digital computers, such as laptops, desktops, workstations, personal digital assistants, servers, blade servers, mainframes, and other appropriate computers, including vehicles installed on base units or pod units of modular vehicles. The system 800 can also include mobile devices, such as personal digital assistants, cellular telephones, smartphones, and other similar computing devices. Additionally, the system can include portable storage media, such as Universal Serial Bus (USB) flash drives. For example, the USB flash drives can store operating systems and other applications. The USB flash drives can include input/output components, such as a wireless transducer or USB connector that can be inserted into a USB port of another computing device.

The system 800 includes a processor 810, a memory 820, a storage device 830, and an input/output device 840. Each of the components 810, 820, 830, and 840 are interconnected using a system bus 850. The processor 810 is capable of processing instructions for execution within the system 800. The processor can be designed using any of a number of architectures. For example, the processor 810 can be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the system 800. In one implementation, the storage device 830 is a computer-readable medium. In various different implementations, the storage device 830 can be a floppy disk device, a hard disk device, an optical disk device, or a tape device.

The input/output device 840 provides input/output operations for the system 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

In addition to the embodiments described above, the following embodiments are also innovative.

Embodiment 1 an article comprising: a first layer comprising lithium; and a support structure comprising a plate having a surface supporting the first layer, the support structure comprising one or more channels adjacent the plate defining a continuous fluid path connecting an inlet channel to an outlet channel, the one or more channels comprising non-planar channel segments following curved paths.

Embodiment 2 is the article of embodiment 1, wherein the one or more channels are defined by a continuously curving wall.

Embodiment 3 is the article of any one of embodiments 1 to 2, wherein the support structure is formed in an additive manufacturing operation.

Embodiment 4 is the article of any one of embodiments 1 to 3, wherein the support structure comprises a monolithic structure.

Embodiment 5 is the article of any one of embodiments 1 to 4, wherein the support structure comprises a three-dimensional single-piece construction.

Embodiment 6 is the article of any one of embodiments 1 to 5, wherein the support structure is devoid of braze and weld joints.

Embodiment 7 is the article of any one of embodiments 1 to 6, wherein the one or more channels are fluidly coupled to each other.

Embodiment 8 is the article of any one of embodiments 1 to 7, wherein the support structure includes the inlet channel and the outlet channel.

Embodiment 9 is the article of any one of embodiments 1 to 8, wherein the surface comprises a planar surface.

Embodiment 10 is the article of any one of embodiments 1 to 9, wherein the article has a rectangular shape, and a length of the article is from 5 centimeters (cm) to 20 cm.

Embodiment 11 is the article of any one of embodiments 1 to 10, comprising a neutron generation target.

Embodiment 12 is the article of any one of embodiments 1 to 11, wherein a weight of the article is from 500 grams to 1,000 grams.

Embodiment 13 is the article of any one of embodiments 1 to 12, wherein the article has a circular shape and the diameter of the article is from 5 centimeters (cm) to 20 cm.

Embodiment 14 is the article of any one of embodiments 1 to 13, wherein the support structure comprises one or more materials, a thermal conductivity of the one or more materials being from 300 W×m⁻¹×K⁻¹ to 1000 W×m⁻¹×K⁻¹ or from 50 W×m⁻¹×K⁻¹ to 300 W×m⁻¹×K⁻¹.

Embodiment 15 is the article of any one of embodiments 1 to 14, wherein the one or more channels consist of non-planar channel segments following curved paths.

Embodiment 16 is the article of any one of embodiments 1 to 15, wherein the support structure is formed from copper.

Embodiment 17 is the article of any one of embodiments 1 to 16, wherein a thickness of the plate is from 1 millimeter (mm) to 8 mm.

Embodiment 18 is the article of any one of embodiments 1 to 17, wherein the thickness of the plate is selected from 2 mm, 3 mm, 4 mm, 5 mm, 6 mm, or 7 mm.

Embodiment 19 is the article of any one of embodiments 1 to 18, wherein the plate is 2 times, 5 times, 10 times, 20 times, 50 times, 60 times, 70 times, 80 times, 90 times, or 100 times thicker than the first layer.

Embodiment 20 is the article of any one of embodiments 1 to 19, wherein the first layer comprises from 92 percent by weight (wt %) to 98 wt % of Li7 isotope.

Embodiment 21 is the article of any one of embodiments 1 to 20, wherein a thickness of the first layer is from 15 micrometers (μm) to 180 μm.

Embodiment 22 is the article of any one of embodiments 1 to 21, wherein the thickness of the first layer is from 90 μm to 100 μm.

Embodiment 23 is the article of any one of embodiments 1 to 22, wherein the first layer is supported by the surface of the plate by being bonded to the surface of the plate through metallic bonds, electrostatic interactions, intermaterial diffusion, or any combination thereof.

Embodiment 24 is the article of any one of embodiments 1 to 23, wherein a thickness of the support structure is from 10 mm to 50 mm.

Embodiment 25 is a heat transfer unit comprising a plate and one or more channels adjacent the plate defining a continuous fluid path connecting an inlet channel to an outlet channel, the one or more channels comprising non-planar channel segments following curved paths.

Embodiment 26 is the heat transfer unit of embodiment 25, wherein the one or more channels are defined by a continuously curving wall.

Embodiment 27 is the heat transfer unit of any one of embodiments 25 to 26, wherein the heat transfer unit is formed in an additive manufacturing operation.

Embodiment 28 is the heat transfer unit of any one of embodiments 25 to 27, comprising a monolithic structure.

Embodiment 29 is the heat transfer unit of any one of embodiments 25 to 28, comprising a three-dimensional single-piece construction.

Embodiment 30 is the heat transfer unit of any one of embodiments 25 to 29, wherein the heat transfer unit is devoid of braze and weld joints.

Embodiment 31 is the heat transfer unit of any one of embodiments 25 to 30, wherein the one or more channels consist of non-planar channel segments following curved paths and are fluidly coupled to each other.

Embodiment 32 is the heat transfer unit of any one of embodiments 25 to 31, wherein the heat transfer unit includes the inlet channel and the outlet channel.

Embodiment 33 is the heat transfer unit of any one of embodiments 25 to 32, wherein the surface comprises a planar surface.

Embodiment 34 is the heat transfer unit of any one of embodiments 25 to 33, wherein the heat transfer unit has a rectangular shape, and a length of the heat transfer unit is from 5 cm to 20 cm.

Embodiment 35 is the heat transfer unit of any one of embodiments 25 to 34, wherein heat transfer unit is formed from copper.

Embodiment 36 is the heat transfer unit of any one of embodiments 25 to 35, wherein a thickness of the plate is from 1 mm to 8 mm.

Embodiment 37 is the heat transfer unit of any one of embodiments 25 to 36, wherein the thickness of the plate is selected from 2 mm, 3 mm, 4 mm, 5 mm, 6 mm, or 7 mm.

Embodiment 38 is the heat transfer unit of any one of embodiments 25 to 37, wherein a thickness of the heat transfer unit is from 10 mm to 50 mm.

Embodiment 39 is a system comprising: an ion source configured to generate an ion beam; and a tandem accelerator configured to accelerate the ion beam, convert the ion beam to a proton beam, and accelerate the proton beam towards a neutron-generating target, the neutron generating target being configured to emit a neutron beam along a beam path to an object and comprising: a first layer comprising lithium; and a support structure comprising a plate having a surface supporting the first layer, the support structure comprising one or more channels adjacent the plate defining a continuous fluid path connecting an inlet channel to an outlet channel, the one or more channels comprising non-planar channel segments following curved paths.

Embodiment 40 is the system of embodiment 39, wherein the one or more channels are defined by a continuously curving wall.

Embodiment 41 is the system of any one of embodiments 39 to 40, wherein the support structure is formed in an additive manufacturing operation.

Embodiment 42 is the system of any one of embodiments 39 to 41, wherein the support structure comprises a monolithic structure.

Embodiment 43 is the system of any one of embodiments 39 to 42, wherein the support structure comprises a three-dimensional single-piece construction.

Embodiment 44 is the system of any one of embodiments 39 to 43, wherein the support structure is devoid of braze and weld joints.

Embodiment 45 is the system of any one of embodiments 39 to 44, wherein the one or more channels are fluidly coupled to each other.

Embodiment 46 is the system of any one of embodiments 39 to 45, wherein the support structure includes the inlet channel and the outlet channel.

Embodiment 47 is the system of any one of embodiments 39 to 46, wherein the surface comprises a planar surface.

Embodiment 48 is the system of any one of embodiments 39 to 47, wherein the neutron-generating target has a rectangular shape, and a length of the neutron-generating target is from 5 centimeters (cm) to 20 cm.

Embodiment 49 is the system of any one of embodiments 39 to 48, wherein a weight of the neutron-generating target is from 500 grams to 1,000 grams.

Embodiment 50 is the system of any one of embodiments 39 to 49, wherein the neutron-generating target has a circular shape and the diameter of the neutron-generating target is from 5 centimeters (cm) to 20 cm.

Embodiment 51 is the system of any one of embodiments 39 to 50, wherein the support structure comprises one or more materials, a thermal conductivity of the one or more materials being from 300 W×m⁻¹×K⁻¹ to 1000 W×m⁻¹×K⁻¹ or from 50 W×m⁻¹×K⁻¹ to 300 W×m⁻¹×K⁻¹.

Embodiment 52 is the system of any one of embodiments 39 to 51, wherein the one or more channels consist of non-planar channel segments following curved paths.

Embodiment 53 is the system of any one of embodiments 39 to 52, wherein the support structure is formed from copper.

Embodiment 54 is the system of any one of embodiments 39 to 53, wherein a thickness of the plate is from 1 mm to 8 mm.

Embodiment 55 is the system of any one of embodiments 39 to 54, wherein the thickness of the plate is selected from 2 mm, 3 mm, 4 mm, 5 mm, 6 mm, or 7 mm.

Embodiment 56 is the system of any one of embodiments 39 to 55, wherein the plate is 2 times, 5 times, 10 times, 20 times, 50 times, 60 times, 70 times, 80 times, 90 times, or 100 times thicker than the first layer.

Embodiment 57 is the system of any one of embodiments 39 to 56, wherein the first layer comprises from 92 percent by weight (wt %) to 98 wt % of Li7 isotope.

Embodiment 58 is the system of any one of embodiments 39 to 57, wherein a thickness of the first layer is from 15 micrometers (μm) to 180 μm.

Embodiment 59 is the system of any one of embodiments 39 to 58, wherein the thickness of the first layer is from 90 μm to 100 μm.

Embodiment 60 is the system of any one of embodiments 39 to 59, wherein the first layer is supported by the surface of the plate by being bonded to the surface of the plate through metallic bonds, electrostatic interactions, intermaterial diffusion, or any combination thereof.

Embodiment 61 is the system of any one of embodiments 39 to 60, wherein a thickness of the support structure is from 10 mm to 50 mm.

Embodiment 62 is an article, comprising: a first layer comprising lithium; and a support structure comprising a plate having a surface supporting the first layer, the support structure comprising one or more channels adjacent the plate defining a continuous fluid path connecting an inlet channel to an outlet channel, the one or more channels being defined by a surface having a gyroidal shape.

Embodiment 63 is the article of embodiment 62, wherein the one or more channels are defined by a continuously curving wall.

Embodiment 64 is the article of any one of embodiments 62 to 63, wherein the support structure is formed in an additive manufacturing operation.

Embodiment 65 is the article of any one of embodiments 62 to 64, wherein the support structure comprises a monolithic structure.

Embodiment 66 is the article of any one of embodiments 62 to 65, wherein the support structure comprises a three-dimensional single-piece construction.

Embodiment 67 is the article of any one of embodiments 62 to 66, wherein the support structure is devoid of braze and weld joints.

Embodiment 68 is the article of any one of embodiments 62 to 67, wherein the one or more channels are fluidly coupled to each other.

Embodiment 69 is the article of any one of embodiments 62 to 68, wherein the support structure includes the inlet channel and the outlet channel.

Embodiment 70 is the article of any one of embodiments 62 to 69, wherein the surface comprises a planar surface.

Embodiment 71 is the article of any one of embodiments 62 to 70, wherein the article has a rectangular shape, and a length of the article is from 5 centimeters (cm) to 20 cm.

Embodiment 72 is the article of any one of embodiments 62 to 71, comprising a neutron generation target.

Embodiment 73 is the article of any one of embodiments 62 to 72, wherein a weight of the article is from 500 grams to 1,000 grams.

Embodiment 74 is the article of any one of embodiments 62 to 73, wherein the article has a circular shape and the diameter of the article is from 5 cm to 20 cm.

Embodiment 75 is the article of any one of embodiments 62 to 74, wherein the support structure comprises one or more materials, a thermal conductivity of the one or more materials being from 300 W×m⁻¹×K⁻¹ to 1000 W×m⁻¹×K⁻¹.

Embodiment 76 is the article of any one of embodiments 62 to 75, wherein a thermal conductivity of the one or more materials is from 50 W×m⁻¹×K⁻¹ to 300 W×m⁻¹×K⁻¹.

Embodiment 77 is the article of any one of embodiments 62 to 76, wherein the support structure is formed from copper.

Embodiment 78 is the article of any one of embodiments 62 to 77, wherein a thickness of the plate is from 1 millimeter (mm) to 8 mm.

Embodiment 79 is the article of any one of embodiments 62 to 78, wherein the thickness of the plate is selected from 2 mm, 3 mm, 4 mm, 5 mm, 6 mm, or 7 mm.

Embodiment 80 is the article of any one of embodiments 62 to 79, wherein the plate is 2 times, 5 times, 10 times, 20 times, 50 times, 60 times, 70 times, 80 times, 90 times, or 100 times thicker than the first layer.

Embodiment 81 is the article of any one of embodiments 62 to 80, wherein the first layer comprises from 92 percent by weight (wt %) to 98 wt % of Li7 isotope.

Embodiment 82 is the article of any one of embodiments 62 to 81, wherein a thickness of the first layer is from 15 micrometers (μm) to 180 μm.

Embodiment 83 is the article of any one of embodiments 62 to 82, wherein the thickness of the first layer is from 90 μm to 100 μm.

Embodiment 84 is the article of any one of embodiments 62 to 83, wherein the first layer is supported by the surface of the plate by being bonded to the surface of the plate through metallic bonds, electrostatic interactions, intermaterial diffusion, or any combination thereof.

Embodiment 85 is the article of any one of embodiments 62 to 84, wherein a thickness of the support structure is from 10 mm to 50 mm.

Embodiment 86 is a heat transfer unit comprising a plate and one or more channels adjacent the plate defining a continuous fluid path connecting an inlet channel to an outlet channel, the one or more channels being defined by a surface having a gyroidal shape.

Embodiment 87 is the heat transfer unit of embodiment 86, wherein the one or more channels are defined by a continuously curving wall.

Embodiment 88 is the heat transfer unit of any one of embodiments 86 to 87, wherein the heat transfer unit is formed in an additive manufacturing operation.

Embodiment 89 is the heat transfer unit of any one of embodiments 86 to 88, comprising a monolithic structure.

Embodiment 90 is the heat transfer unit of any one of embodiments 86 to 89, comprising a three-dimensional single-piece construction.

Embodiment 91 is the heat transfer unit of any one of embodiments 86 to 90, wherein the heat transfer unit is devoid of braze and weld joints.

Embodiment 92 is the heat transfer unit of any one of embodiments 86 to 91, wherein the one or more channels are fluidly coupled to each other.

Embodiment 93 is the heat transfer unit of any one of embodiments 86 to 92, wherein the heat transfer unit includes the inlet channel and the outlet channel.

Embodiment 94 is the heat transfer unit of any one of embodiments 86 to 93, wherein the surface comprises a planar surface.

Embodiment 95 is the heat transfer unit of any one of embodiments 86 to 94, wherein the heat transfer unit has a rectangular shape, and a length of the heat transfer unit is from 5 cm to 20 cm.

Embodiment 96 is the heat transfer unit of any one of embodiments 86 to 95, wherein heat transfer unit is formed from copper.

Embodiment 97 is the heat transfer unit of any one of embodiments 86 to 96, wherein a thickness of the plate is from 1 millimeter (mm) to 8 mm.

Embodiment 98 is the heat transfer unit of any one of embodiments 86 to 97, wherein the thickness of the plate is selected from 2 mm, 3 mm, 4 mm, 5 mm, 6 mm, or 7 mm.

Embodiment 99 is the heat transfer unit of any one of embodiments 86 to 98, wherein a thickness of the heat transfer unit is from 10 mm to 50 mm.

Embodiment 100 is a system comprising: an ion source configured to generate an ion beam; and a tandem accelerator configured to accelerate the ion beam, convert the ion beam to a proton beam, and accelerate the proton beam towards a neutron-generating target, the neutron generating target being configured to emit a neutron beam along a beam path to an object and comprising: a first layer comprising lithium; and a support structure comprising a plate having a surface supporting the first layer, the support structure comprising one or more channels adjacent the plate defining a continuous fluid path connecting an inlet channel to an outlet channel, the one or more channels being defined by a surface having a gyroidal shape.

Embodiment 101 is the system of embodiment 100, wherein the one or more channels are defined by a continuously curving wall.

Embodiment 102 is the system of any one of embodiments 100 to 101, wherein the support structure is formed in an additive manufacturing operation.

Embodiment 103 is the system of any one of embodiments 100 to 102, wherein the support structure comprises a monolithic structure.

Embodiment 104 is the system of any one of embodiments 100 to 103, wherein the support structure comprises a three-dimensional single-piece construction.

Embodiment 105 is the system of any one of embodiments 100 to 104, wherein the support structure is devoid of braze and weld joints.

Embodiment 106 is the system of any one of embodiments 100 to 105, wherein the one or more channels are fluidly coupled to each other.

Embodiment 107 is the system of any one of embodiments 100 to 106, wherein the support structure includes the inlet channel and the outlet channel.

Embodiment 108 is the system of any one of embodiments 100 to 107, wherein the surface comprises a planar surface.

Embodiment 109 is the system of any one of embodiments 100 to 108, wherein the neutron-generating target has a rectangular shape, and a length of the article is from 5 centimeters (cm) to 20 cm.

Embodiment 110 is the system of any one of embodiments 100 to 109, wherein a weight of the neutron-generating target is from 500 grams to 1,000 grams.

Embodiment 111 is the system of any one of embodiments 100 to 110, wherein the neutron-generating target has a circular shape and the diameter of the neutron-generating target is from 5 centimeters (cm) to 20 cm.

Embodiment 112 is the system of any one of embodiments 100 to 111, wherein the support structure comprises one or more materials, a thermal conductivity of the one or more materials being from 300 W×m⁻¹×K⁻¹ to 1000 W×m⁻¹×K⁻¹.

Embodiment 113 is the system of any one of embodiments 100 to 112, wherein the support structure comprises one or more materials, a thermal conductivity of the one or more materials being from 50 W×m⁻¹×K⁻¹ to 300 W×m⁻¹×K⁻¹.

Embodiment 114 is the system of any one of embodiments 100 to 113, wherein the support structure is formed from copper.

Embodiment 115 is the system of any one of embodiments 100 to 114, wherein a thickness of the plate is from 1 mm to 8 mm.

Embodiment 116 is the system of any one of embodiments 100 to 115, wherein the thickness of the plate is selected from 2 mm, 3 mm, 4 mm, 5 mm, 6 mm, or 7 mm.

Embodiment 117 is the system of any one of embodiments 100 to 116, wherein the plate is 2 times, 5 times, 10 times, 20 times, 50 times, 60 times, 70 times, 80 times, 90 times, or 100 times thicker than the first layer.

Embodiment 118 is the system of any one of embodiments 100 to 117, wherein the first layer comprises from 92 percent by weight (wt %) to 98 wt % of Li7 isotope.

Embodiment 119 is the system of any one of embodiments 100 to 118, wherein a thickness of the first layer is from 15 micrometers (μm) to 180 μm.

Embodiment 120 is the system of any one of embodiments 100 to 119, wherein the thickness of the first layer is from 90 μm to 100 μm.

Embodiment 121 is the system of any one of embodiments 100 to 120, wherein the first layer is supported by the surface of the plate by being bonded to the surface of the plate through metallic bonds, electrostatic interactions, intermaterial diffusion, or any combination thereof.

Embodiment 122 is the system of any one of embodiments 100 to 121, wherein a thickness of the support structure is from 10 mm to 50 mm.

Embodiment 123 is an article comprising: a first layer comprising lithium; and a support structure comprising a plate and a lattice structure abutting the plate, the lattice structure defining a continuous fluid path connecting an inlet channel to an outlet channel the support structure being formed in an additive manufacturing operation.

Embodiment 124 is the article of embodiment 123, wherein: the support structure includes a second plate extending parallel to the plate, and the lattice structure fills a volume between the plate and the second plate.

Embodiment 125 is the article of embodiment 124, wherein: the support structure comprises: an inlet port for entry of fluid to the inlet channel; an outlet port for egress of fluid from the outlet channel; and the second plate is positioned between the lattice structure and the inlet and outlet ports.

Embodiment 126 is the article of embodiment 125, wherein: the inlet channel fluidly couples the volume between the plate and the second plate with the inlet port; and the outlet channel fluidly couples the volume between the plate and the second plate with the outlet port.

Embodiment 127 is the article of any one of embodiments 123 to 126, wherein the lattice structure conforms to the plate.

Embodiment 128 is the article of any one of embodiments 123 to 127, wherein the lattice structure comprises a triply periodic minimal surface having zero mean curvature.

Embodiment 129 is the article of any one of embodiments 123 to 128, wherein the lattice structure excludes straight lines and planar symmetries.

Embodiment 130 is the article of any one of embodiments 123 to 129, wherein the support structure comprises a monolithic structure.

Embodiment 131 is the article of any one of embodiments 123 to 130, wherein the support structure comprises a three-dimensional single-piece construction.

Embodiment 132 is the article of any one of embodiments 123 to 131, wherein the support structure is devoid of braze and weld joints.

Embodiment 133 is the article of any one of embodiments 123 to 132, wherein the support structure includes the inlet channel and the outlet channel.

Embodiment 134 is the article of any one of embodiments 123 to 133, wherein the article has a rectangular shape, and a length of the article is from 5 cm to 20 cm.

Embodiment 135 is the article of any one of embodiments 123 to 134, comprising a neutron generation target.

Embodiment 136 is the article of any one of embodiments 123 to 135, wherein a weight of the article is from 500 grams to 1,000 grams.

Embodiment 137 is the article of any one of embodiments 123 to 136, wherein the article has a circular shape and the diameter of the article is from 5 centimeters (cm) to 20 cm.

Embodiment 138 is the article of any one of embodiments 123 to 137, wherein the support structure is formed from copper.

Embodiment 139 is the article of any one of embodiments 123 to 138, wherein a thickness of the plate is from 1 millimeter (mm) to 8 mm.

Embodiment 140 is the article of any one of embodiments 123 to 139, wherein the thickness of the plate is selected from 2 mm, 3 mm, 4 mm, 5 mm, 6 mm, or 7 mm.

Embodiment 141 is the article of any one of embodiments 123 to 140, wherein the plate is 2 times, 5 times, 10 times, 20 times, 50 times, 60 times, 70 times, 80 times, 90 times, or 100 times thicker than the first layer.

Embodiment 142 is the article of any one of embodiments 123 to 141, wherein the first layer comprises from 92 percent by weight (wt %) to 98 wt % of Li7 isotope.

Embodiment 143 is the article of any one of embodiments 123 to 142, wherein a thickness of the first layer is from 15 micrometers (μm) to 180 μm.

Embodiment 144 is the article of any one of embodiments 123 to 143, wherein the thickness of the first layer is from 90 μm to 100 μm.

Embodiment 145 is the article of any one of embodiments 123 to 144, wherein the first layer is supported by the plate by being bonded to the plate through metallic bonds, electrostatic interactions, intermaterial diffusion, or any combination thereof.

Embodiment 146 is the article of any one of embodiments 123 to 145, wherein a thickness of the support structure is from 10 mm to 50 mm.

Embodiment 147 is a heat transfer unit comprising a plate and a lattice structure abutting the plate, the lattice structure defining a continuous fluid path connecting an inlet channel to an outlet channel, the heat transfer unit being formed in an additive manufacturing operation.

Embodiment 148 is the heat transfer unit of embodiment 147, wherein: the support structure includes a second plate extending parallel to the plate, and the lattice structure fills a volume between the plate and the second plate.

Embodiment 149 is the heat transfer unit of embodiment 148, wherein: the support structure comprises: an inlet port for entry of fluid to the inlet channel; an outlet port for egress of fluid from the outlet channel; and the second plate is positioned between the lattice structure and the inlet and outlet ports.

Embodiment 150 is the heat transfer unit embodiment 149, wherein: the inlet channel fluidly couples the volume between the plate and the second plate with the inlet port; and the outlet channel fluidly couples the volume between the plate and the second plate with the outlet port.

Embodiment 151 is the heat transfer unit of any one of embodiments 147 to 150, wherein the lattice structure conforms to the plate.

Embodiment 152 is the heat transfer unit of any one of embodiments 147 to 151, wherein the lattice structure comprises a triply periodic minimal surface having zero mean curvature.

Embodiment 153 is the heat transfer unit of any one of embodiments 147 to 152, wherein the lattice structure excludes straight lines and planar symmetries.

Embodiment 154 is the heat transfer unit of any one of embodiments 147 to 153, comprising a monolithic structure.

Embodiment 155 is the heat transfer unit of any one of embodiments 147 to 154, comprising a three-dimensional single-piece construction.

Embodiment 156 is the heat transfer unit of any one of embodiments 147 to 155, wherein the heat transfer unit is devoid of braze and weld joints.

Embodiment 157 is the heat transfer unit of any one of embodiments 147 to 156, wherein the heat transfer unit includes the inlet channel and the outlet channel.

Embodiment 158 is the heat transfer unit of any one of embodiments 147 to 157, wherein the heat transfer unit has a rectangular shape, and a length of the heat transfer unit is from 5 cm to 20 cm.

Embodiment 159 is the heat transfer unit of any one of embodiments 147 to 158, wherein heat transfer unit is formed from copper.

Embodiment 160 is the heat transfer unit of any one of embodiments 147 to 159, wherein a thickness of the plate is from 1 millimeter (mm) to 8 mm.

Embodiment 161 is the heat transfer unit of any one of embodiments 147 to 160, wherein the thickness of the plate is selected from 2 mm, 3 mm, 4 mm, 5 mm, 6 mm, or 7 mm.

Embodiment 162 is the heat transfer unit of any one of embodiments 147 to 161, wherein a thickness of the heat transfer unit is from 10 mm to 50 mm.

Embodiment 163 is a system comprising: an ion source configured to generate an ion beam; and a tandem accelerator configured to accelerate the ion beam, convert the ion beam to a proton beam, and accelerate the proton beam towards a neutron-generating target, the neutron generating target being configured to emit a neutron beam along a beam path to an object and comprising: a first layer comprising lithium; and a support structure comprising a plate and a lattice structure abutting the plate, the lattice structure defining a continuous fluid path connecting an inlet channel to an outlet channel, the support structure being formed in an additive manufacturing operation.

Embodiment 164 is the system of embodiment 163, wherein: the support structure includes a second plate extending parallel to the plate, and the lattice structure fills a volume between the plate and the second plate.

Embodiment 165 is the system of embodiment 164, wherein: the support structure comprises: an inlet port for entry of fluid to the inlet channel; an outlet port for egress of fluid from the outlet channel; and the second plate is positioned between the lattice structure and the inlet and outlet ports.

Embodiment 166 is the system of embodiment 165, wherein: the inlet channel fluidly couples the volume between the plate and the second plate with the inlet port; and the outlet channel fluidly couples the volume between the plate and the second plate with the outlet port.

Embodiment 167 is the system of any one of embodiments 163 to 166, wherein the lattice structure conforms to the plate.

Embodiment 168 is the system of any one of embodiments 163 to 167, wherein the lattice structure comprises a triply periodic minimal surface having zero mean curvature.

Embodiment 169 is the system of any one of embodiments 163 to 168, wherein the lattice structure excludes straight lines and planar symmetries.

Embodiment 170 is the system of any one of embodiments 163 to 169, wherein the support structure comprises a monolithic structure.

Embodiment 171 is the system of any one of embodiments 163 to 170, wherein the support structure comprises a three-dimensional single-piece construction.

Embodiment 172 is the system of any one of embodiments 163 to 171, wherein the support structure is devoid of braze and weld joints.

Embodiment 173 is the system of any one of embodiments 163 to 172, wherein the support structure includes the inlet channel and the outlet channel.

Embodiment 174 is the system of any one of embodiments 163 to 173, wherein the neutron-generating target has a rectangular shape, and a length of the article is from 5 centimeters (cm) to 20 cm.

Embodiment 175 is the system of any one of embodiments 163 to 174, wherein a weight of the neutron-generating target is from 500 grams to 1,000 grams.

Embodiment 176 is the system of any one of embodiments 163 to 175, wherein the neutron-generating target has a circular shape and the diameter of the neutron-generating target is from 5 centimeters (cm) to 20 cm.

Embodiment 177 is the system of any one of embodiments 163 to 176, wherein the support structure comprises one or more materials, a thermal conductivity of the one or more materials being from 300 W×m⁻¹×K⁻¹ to 1000 W×m⁻¹×K⁻¹.

Embodiment 178 is the system of any one of embodiments 163 to 177, wherein the support structure comprises one or more materials, a thermal conductivity of the one or more materials being from 50 W×m⁻¹×K⁻¹ to 300 W×m⁻¹×K⁻¹.

Embodiment 179 is the system of any one of embodiments 163 to 178, wherein the support structure is formed from copper.

Embodiment 180 is the system of any one of embodiments 163 to 179, wherein a thickness of the plate is from 1 mm to 8 mm.

Embodiment 181 is the system of any one of embodiments 163 to 180, wherein the thickness of the plate is selected from 2 mm, 3 mm, 4 mm, 5 mm, 6 mm, or 7 mm.

Embodiment 182 is the system of any one of embodiments 163 to 181, wherein the plate is 2 times, 5 times, 10 times, 20 times, 50 times, 60 times, 70 times, 80 times, 90 times, or 100 times thicker than the first layer.

Embodiment 183 is the system of any one of embodiments 163 to 182, wherein the first layer comprises from 92 percent by weight (wt %) to 98 wt % of Li7 isotope.

Embodiment 184 is the system of any one of embodiments 163 to 183, wherein a thickness of the first layer is from 15 micrometers (μm) to 180 μm.

Embodiment 185 is the system of any one of embodiments 163 to 184, wherein the thickness of the first layer is from 90 μm to 100 μm.

Embodiment 186 is a method for making an article for irradiation, comprising: providing one or more materials for a support structure to a three-dimensional printer device; providing instructions to the three-dimensional printer device to prepare the support structure, the support structure comprising a plate and one or more channels adjacent to the plate, the one or more channels defined by a surface having a gyroidal form; obtaining a material containing lithium; and contacting the plate of the support structure with the material containing lithium to obtain the article.

Embodiment 187 is the method of embodiment 186, wherein the one or more channels are defined by a continuously curving wall.

Embodiment 188 is the method of any one of embodiments 186 to 187, wherein the support structure is formed in an additive manufacturing operation.

Embodiment 189 is the method of any one of embodiments 186 to 188, wherein the support structure comprises a monolithic structure.

Embodiment 190 is the method of any one of embodiments 186 to 189, wherein the support structure comprises a three-dimensional single-piece construction.

Embodiment 191 is the method of any one of embodiments 186 to 190, wherein the support structure is devoid of braze and weld joints.

Embodiment 192 is the method of any one of embodiments 186 to 191, wherein the one or more channels are fluidly coupled to each other.

Embodiment 193 is the method of any one of embodiments 186 to 192, wherein the three-dimensional printer device is configured to receive and store the one or more materials for making the support structure.

Embodiment 194 is the method of any one of embodiments 186 to 193, wherein the three-dimensional printer device is selected from a fused deposition modeling printer, a stereolithography printer, a digital light processing printer, a selective laser sintering printer, a selective laser melting printer, a laminated object manufacturing printer, a digital beam melting printer, or any combination thereof.

Embodiment 195 is a method of making an article for irradiation, the article comprising: a first layer comprising lithium; and a support structure comprising a plate having a surface supporting the first layer, the support structure comprising one or more channels adjacent the plate defining a continuous fluid path connecting an inlet channel to an outlet channel, the one or more channels comprising non-planar channel segments following curved paths, the method comprising contacting the surface of the plate of the support structure with the first layer comprising lithium to obtain the article.

Embodiment 196 is the method of embodiment 195, wherein the one or more channels are defined by a continuously curving wall.

Embodiment 197 is the method of any one of embodiments 195 to 196, wherein the support structure is formed in an additive manufacturing operation.

Embodiment 198 is the method of any one of embodiments 195 to 197, wherein the support structure comprises a monolithic structure.

Embodiment 199 is the method of any one of embodiments 195 to 198, wherein the support structure comprises a three-dimensional single-piece construction.

Embodiment 200 is the method of any one of embodiments 195 to 199, wherein the support structure is devoid of braze and weld joints.

Embodiment 201 is the method of any one of embodiments 195 to 200, wherein the one or more channels consist of non-planar channel segments following curved paths and are fluidly coupled to each other.

Embodiment 202 is the method of any one of embodiments 195 to 201, wherein the support structure includes the inlet channel and the outlet channel.

Embodiment 203 is the method of any one of embodiments 195 to 202, wherein the surface comprises a planar surface.

Embodiment 204 is a method of treating a cancer in a subject, the method comprising: administering to the subject a therapeutically effective amount of a compound comprising B¹⁰, waiting a sufficient amount of time for the compound comprising B¹⁰ to accumulate in a cancer tissue within the subject, contacting an article of any one of any one of embodiments 1-24 with a beam of protons to produce a beam of neutrons, and directing the beam of neutrons to the cancer tissue.

Embodiment 205 is the method of embodiment 204, wherein the cancer is selected from liver cancer, oral cancer, colon cancer, brain cancer, head and neck cancer, lung cancer, breast cancer, gastric cancer, extensive squamous cell carcinoma, laryngeal cancer, melanoma, sarcoma, and extramammary Paget's disease.

Embodiment 206 is the method of embodiment 205, wherein the liver cancer is selected from hepatocellular carcinoma, intrahepatic cholangiocarcinoma, hepatoblastoma, and hepatic adenoma.

Embodiment 207 is the method of embodiment 205, wherein the brain cancer is selected from glioblastoma, meningioma, and medulloblastoma.

Embodiment 208 is the method of any one of embodiments 204 to 207, wherein the cancer is a recurrent cancer.

Embodiment 209 is the method of any one of embodiments 204 to 208, wherein the cancer is a metastatic cancer.

Embodiment 210 is the method of any one of embodiments 204 to 209, wherein the therapeutic amount is from 1 milligram (mg) to 100 mg of B¹⁰ per one kilogram (kg) of the subject's body weight.

Embodiment 211 is the method of any one of embodiments 204 to 210, wherein the compound comprising B¹⁰ is selected from boronophenylalanine, borocaptate sodium, or 1-amino-3-boronocyclo-pentanecarboxylic acid.

Embodiment 212 is the method of any one of embodiments 204 to 211, wherein the compound comprising B¹⁰ accumulates in the cancer tissue at a level from 20 to 50 microgram (μg) of B¹⁰ per gram (g) of tumor.

Embodiment 213 is the method of any one of embodiments 204 to 212, wherein the sufficient amount of time is from 30 sec to 1 h.

Embodiment 214 is the method of any one of embodiments 204 to 213, wherein energy of the beam of protons is from 2 MeV to 3 MeV.

Embodiment 215 is the method of any one of embodiments 204 to 214, comprising cooling the article during contacting to maintain its operating temperature from 130 degrees Celsius (° C.) to 150° C.

Embodiment 216 is the method of embodiment 215, wherein the cooling comprises flowing a coolant fluid through the one or more channels adjacent to the plate of the support structure thereby removing heat from the support structure.

Embodiment 217 is the method of embodiment 216, wherein the coolant fluid is selected from water, an alcohol, an antifreeze, or a combination thereof.

Embodiment 218 is the method of any one of embodiments 216 to 217, wherein the coolant fluid is water.

Embodiment 219 is the method of any one of embodiments 216 to 218, wherein the coolant fluid is substantially degassed.

Embodiment 220 is the method of any one of embodiments 216 to 219, wherein a flow rate of the coolant fluid is from 10 kilogram per minute (kg/min) to 200 kg/min.

Embodiment 221 is the method of any one of embodiments 216 to 220, wherein the flowing comprises a laminar flow.

Embodiment 222 is the method of any one of embodiments 216 to 221, wherein an inlet temperature of the coolant fluid is from 5° C. to 30° C., and an outlet temperature of the coolant fluid is from 40° C. to 90° C.

Embodiment 223 is the method of any one of embodiments 216 to 222, wherein an inlet pressure of the coolant fluid is from 100 kiloPascal (kPa) to 200 kPa, and an outlet pressure of the coolant fluid is from 80 kPa to 180 kPa.

Embodiment 224 is a method of treating a cancer in a subject, the method comprising: administering to the subject a therapeutically effective amount of a compound comprising B¹⁰, waiting a sufficient amount of time for the compound comprising B¹⁰ to accumulate in a cancer tissue within the subject, contacting an article of any one of any one of embodiments 62-85 with a beam of protons to produce a beam of neutrons, and directing the beam of neutrons to the cancer tissue.

Embodiment 225 is the method of embodiment 224, wherein the cancer is selected from liver cancer, oral cancer, colon cancer, brain cancer, head and neck cancer, lung cancer, breast cancer, gastric cancer, extensive squamous cell carcinoma, laryngeal cancer, melanoma, sarcoma, and extramammary Paget's disease.

Embodiment 226 is the method of embodiment 225, wherein the liver cancer is selected from hepatocellular carcinoma, intrahepatic cholangiocarcinoma, hepatoblastoma, and hepatic adenoma.

Embodiment 227 is the method embodiment 225, wherein the brain cancer is selected from glioblastoma, meningioma, and medulloblastoma.

Embodiment 228 is the method of any one of embodiments 224 to 227, wherein the cancer is a recurrent cancer.

Embodiment 229 is the method of any one of embodiments 224 to 228, wherein the cancer is a metastatic cancer.

Embodiment 230 is the method of any one of embodiments 224 to 229, wherein the therapeutic amount is from 1 milligram (mg) to 100 mg of B¹⁰ per one kilogram (kg) of the subject's body weight.

Embodiment 231 is the method of any one of embodiments 224 to 230, wherein the compound comprising B¹⁰ is selected from boronophenylalanine, borocaptate sodium, or 1-amino-3-boronocyclo-pentanecarboxylic acid.

Embodiment 232 is the method of any one of embodiments 224 to 231, wherein the compound comprising B¹⁰ accumulates in the cancer tissue at a level from 20 to 50 microgram (μg) of B¹⁰ per gram (g) of tumor.

Embodiment 233 is the method of any one of embodiments 224 to 232, wherein the sufficient amount of time is from 30 sec to 1 h.

Embodiment 234 is the method of any one of embodiments 224 to 233, wherein energy of the beam of protons is from 2 MeV to 3 MeV.

Embodiment 235 is the method of any one of embodiments 224 to 234, comprising cooling the article during contacting to maintain its operating temperature from 130 degrees Celsius (° C.) to 150° C.

Embodiment 236 is the method of any embodiment 235, wherein the cooling comprises flowing a coolant fluid through the one or more channels adjacent to the plate of the support structure thereby removing heat from the support structure.

Embodiment 237 is the method of embodiment 236, wherein the coolant fluid is selected from water, an alcohol, an antifreeze, or a combination thereof.

Embodiment 238 is the method of any one of embodiments 236 to 237, wherein the coolant fluid is water.

Embodiment 239 is the method of any one of embodiments 236 to 238, wherein the coolant fluid is substantially degassed.

Embodiment 240 is the method of any one of embodiments 236 to 239, wherein a flow rate of the coolant fluid is from 10 kilogram per minute (kg/min) to 200 kg/min.

Embodiment 241 is the method of any one of embodiments 236 to 240, wherein the flowing comprises a laminar flow.

Embodiment 242 is the method of any one of embodiments 236 to 241, wherein an inlet temperature of the coolant fluid is from 5° C. to 30° C., and an outlet temperature of the coolant fluid is from 40° C. to 90° C.

Embodiment 243 is the method of any one of embodiments 236 to 242, wherein an inlet pressure of the coolant fluid is from 100 kiloPascal (kPa) to 200 kPa, and an outlet pressure of the coolant fluid is from 80 kPa to 180 kPa.

Embodiment 244 is a method of treating a cancer in a subject, the method comprising: administering to the subject a therapeutically effective amount of a compound comprising B¹⁰, waiting a sufficient amount of time for the compound comprising B¹⁰ to accumulate in a cancer tissue within the subject, contacting an article of any one of any one of embodiments 123-146 with a beam of protons to produce a beam of neutrons, and directing the beam of neutrons to the cancer tissue.

Embodiment 245 is the method of embodiment 244, wherein the cancer is selected from liver cancer, oral cancer, colon cancer, brain cancer, head and neck cancer, lung cancer, breast cancer, gastric cancer, extensive squamous cell carcinoma, laryngeal cancer, melanoma, sarcoma, and extramammary Paget's disease.

Embodiment 246 is the method of embodiment 245, wherein the liver cancer is selected from hepatocellular carcinoma, intrahepatic cholangiocarcinoma, hepatoblastoma, and hepatic adenoma.

Embodiment 247 is the method embodiment 245, wherein the brain cancer is selected from glioblastoma, meningioma, and medulloblastoma.

Embodiment 248 is the method of any one of embodiments 244 to 247, wherein the cancer is a recurrent cancer.

Embodiment 249 is the method of any one of embodiments 244 to 248, wherein the cancer is a metastatic cancer.

Embodiment 250 is the method of any one of embodiments 244 to 249, wherein the therapeutic amount is from 1 milligram (mg) to 100 mg of B¹ per one kilogram (kg) of the subject's body weight.

Embodiment 251 is the method of any one of embodiments 244 to 250, wherein the compound comprising B¹⁰ is selected from boronophenylalanine, borocaptate sodium, or 1-amino-3-boronocyclo-pentanecarboxylic acid.

Embodiment 252 is the method of any one of embodiments 244 to 251, wherein the compound comprising B¹⁰ accumulates in the cancer tissue at a level from 20 to 50 microgram (μg) of B¹⁰ per gram (g) of tumor.

Embodiment 253 is the method of any one of embodiments 244 to 252, wherein the sufficient amount of time is from 30 sec to 1 h.

Embodiment 254 is the method of any one of embodiments 244 to 253, wherein energy of the beam of protons is from 2 MeV to 3 MeV.

Embodiment 255 is the method of any one of embodiments 244 to 254, comprising cooling the article during contacting to maintain its operating temperature from 130 degrees Celsius (° C.) to 150° C.

Embodiment 256 is the method of embodiment 255, wherein the cooling comprises flowing a coolant fluid through the one or more channels adjacent to the plate of the support structure thereby removing heat from the support structure.

Embodiment 257 is the method of embodiment 256, wherein the coolant fluid is selected from water, an alcohol, an antifreeze, or a combination thereof.

Embodiment 258 is the method of any one of embodiments 256 to 257, wherein the coolant fluid is water.

Embodiment 259 is the method of any one of embodiments 256 to 258, wherein the coolant fluid is substantially degassed.

Embodiment 260 is the method of any one of embodiments 256 to 259, wherein a flow rate of the coolant fluid is from 10 kilogram per minute (kg/min) to 200 kg/min.

Embodiment 261 is the method of any one of embodiments 256 to 260, wherein the flowing comprises a laminar flow.

Embodiment 262 is the method of any one of embodiments 256 to 261, wherein an inlet temperature of the coolant fluid is from 5° C. to 30° C., and an outlet temperature of the coolant fluid is from 40° C. to 90° C.

Embodiment 263 is the method of any one of embodiments 256 to 262, wherein an inlet pressure of the coolant fluid is from 100 kiloPascal (kPa) to 200 kPa, and an outlet pressure of the coolant fluid is from 80 kPa to 180 kPa.

Embodiment 264 is an article comprising: a support structure comprising a plate having a surface, the support structure comprising one or more channels adjacent the plate defining a continuous fluid path connecting an inlet channel to an outlet channel, the one or more channels comprising non-planar channel segments, wherein each channel segment has fluid inputs along two dimensions of a three dimensional coordinate geometry (X, Y, Z), and wherein each channel segment has fluid outputs along two dimensions of the three dimensional coordinate geometry.

Embodiment 265 is the article of embodiment 264, wherein a plurality of channel segments of the one or more channels has fluid inputs along all three dimensions of the three dimensional coordinate geometry (X, Y, Z).

Embodiment 266 is the article of any one of embodiments 264 or 265, wherein a plurality of channel segments of the one or more channels has fluid outputs along all three dimensions of the three dimensional coordinate geometry (X, Y, Z).

Embodiment 267 is a method for making an article for irradiation, comprising: providing one or more materials for a support structure to a three-dimensional printer device; and providing instructions to the three-dimensional printer device to prepare the support structure, the support structure comprising a plate and a lattice structure abutting the plate, the lattice structure defining a continuous fluid path connecting an inlet channel to an outlet channel.

Embodiment 268 is a method for making an article for irradiation, comprising: contacting a plate of a support structure with material containing lithium, the support structure comprising a lattice structure abutting the plate, the lattice structure defining a continuous fluid path connecting an inlet channel to an outlet channel.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

Other systems, devices, methods, features, and advantages of the subject matter described herein will be or will become apparent to one with skill in the art upon examination of the following figures and detailed description. It is intended that all such additional systems, methods, features, and advantages be included within this description, be within the scope of the subject matter described herein and be protected by the accompanying claims. In no way should the features of the examples be construed as limiting the appended claims, absent express recitation of those features in the claims.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations have been described. Nevertheless, it will be understood that various modifications may be made without departing from the spirit and scope of the disclosure. For example, various forms of the flows shown above may be used, with steps re-ordered, added, or removed. Actions of the disclosed methods can be performed in any order, and may be performed simultaneously. Accordingly, other implementations are within the scope of the following claims.

1. An article comprising:
a first layer comprising lithium; and
a support structure comprising a plate having a surface supporting the first layer, the support structure comprising one or more channels adjacent the plate defining a continuous fluid path connecting an inlet channel to an outlet channel, the one or more channels comprising non-planar channel segments following curved paths.

2. The article of claim 1, wherein the one or more channels are (a) defined by a continuously curving wall and (b) fluidly coupled to each other.

3. The article of claim 1, wherein the support structure comprises a monolithic structure that is formed in an additive manufacturing operation.

4. (canceled)

5. The article of claim 1, wherein the support structure comprises a three-dimensional single-piece construction that is devoid of braze and weld joints.

6-7. (canceled)

8. The article of claim 1, wherein the support structure includes the inlet channel and the outlet channel.

9. The article of claim 1, wherein the surface comprises a planar surface and the first layer is supported by the surface by being bonded to the surface through metallic bonds, electrostatic interactions, intermaterial diffusion, or any combination thereof.

10. The article of claim 1, wherein the article has a rectangular shape, and a length of the article is from 5 centimeters (cm) to 20 cm.

11. The article of claim 1, comprising a neutron generation target.

12. The article of claim 1, wherein a weight of the article is from 500 grams to 1,000 grams.

13. The article of claim 1, wherein the article has a circular shape and the diameter of the article is from 5 centimeters (cm) to 20 cm.

14. The article of claim 1, wherein the support structure comprises one or more materials, a thermal conductivity of the one or more materials being from 300 W×m⁻¹×K⁻¹ to 1000 W×m⁻¹×K⁻¹ or from 50 W×m⁻¹×K⁻¹ to 300 W×m⁻¹×K⁻¹.

15. The article of claim 1, wherein the one or more channels consist of non-planar channel segments following curved paths.

16. The article of claim 1, wherein the support structure is formed from copper.

17. The article of claim 1, wherein:
a thickness of the plate is from 1 millimeter (mm) to 8 mm, and
the plate is 2 times, 5 times, 10 times, 20 times, 50 times, 60 times, 70 times, 80 times, 90 times, or 100 times thicker than the first layer.

18. The article of claim 1, wherein the thickness of the plate is selected from 2 mm, 3 mm, 4 mm, 5 mm, 6 mm, or 7 mm.

19. (canceled)

20. The article of claim 1, wherein the first layer comprises from 92 percent by weight (wt %) to 98 wt % of Li7 isotope.

21. The article of claim 1, wherein:
a thickness of the first layer is from 15 micrometers (μm) to 180 μm, and
a thickness of the support structure is from 10 mm to 50 mm.

22. The article of claim 1, wherein the thickness of the first layer is from 90 μm to 100 μm.

23-24. (canceled)

25. A heat transfer unit comprising a plate and one or more channels adjacent the plate defining a continuous fluid path connecting an inlet channel to an outlet channel, the one or more channels comprising non-planar channel segments following curved paths.

26-38. (canceled)

39. A system comprising:
an ion source configured to generate an ion beam; and
a tandem accelerator configured to accelerate the ion beam, convert the ion beam to a proton beam, and accelerate the proton beam towards a neutron-generating target, the neutron-generating target being configured to emit a neutron beam along a beam path to an object and comprising:
a first layer comprising lithium; and
a support structure comprising a plate having a surface supporting the first layer, the support structure comprising one or more channels adjacent the plate defining a continuous fluid path connecting an inlet channel to an outlet channel, the one or more channels comprising non-planar channel segments following curved paths.

40-268. (canceled)
